(19) United States
(12) Patent Application Publication
(10) Pub. No.: US 2006/0080175 A1
(43) Pub. Date: Apr. 13, 2006

(54) Player scoring for customizing a game of chance on a gaming machine

(75) Inventors: Richard E. Rowe, Incline Village, NV (US); Rich Schneider, Las Vegas, NV (US); Michael Oberberger, Reno, NV (US); Steve Kastner, Las Vegas, NV (US); Steven G. LeMay, Reno, NV (US)

Correspondence Address: BEYER WEAVER & THOMAS LLP, P.O. BOX 70250, OAKLAND, CA, 94612-0250, US

(73) Assignee: International Game Technology

(21) Appl. No.: 11/245,734

(22) Filed: Oct. 6, 2005

Related U.S. Application Data
(63) Continuation of application No. 10/066,176, filed on Feb. 1, 2002.
(60) Provisional application No. 60/266,428, filed on Feb. 2, 2001.

(51) Int. Cl. G06Q 30/00; A63F 9/24; A63F 13/00

(52) U.S. Cl. 705/14; 463/21; 463/16

(57) ABSTRACT

Methods and apparatus are described for customizing a game application for play of a game of chance on a gaming machine. A plurality of attributes are provided. The attributes include at least one attribute relating to gaming behavior of associated individuals. Values of selected attributes associated with ones of a set of individuals are compared with values of the selected attributes associated with others of the individuals. This comparison is performed to determine at least one attribute difference representing a difference among the values of the attributes. A subset of the set of individuals is defined. Each of the individuals in the subset has the one attribute difference in common. Player identification information is received for the player. Responsive to receiving the player identification information, player attributes for the player are retrieved. Based on the retrieved player attributes for the player, it is determined whether the player belongs to the subset of individuals. Attribute differences associated with the subset of individuals are obtained. An element of the game application is defined according to the obtained attribute difference.

### RELATED APPLICATION DATA

This application claims priority from co-pending and commonly assigned U.S. patent application Ser. No. 10/066,176 for UTILIZATION OF SINGLE RELATIONAL POLYMORPHISMS FOR DATA ANALYSIS AND TARGETED MARKETING filed on Feb. 1, 2002 (Attorney Docket No. IGT1P048) which claims priority from U.S. Provisional Patent Application No. 60/266,428 for UTILIZATION OF SINGLE RELATIONAL POLYMORPHISMS FOR DATA ANALYSIS AND TARGETED MARKETING filed on Feb. 2, 2001 (Attorney Docket No. IGT1P048P), both of which are hereby incorporated by reference.

### BACKGROUND OF THE INVENTION

The present invention relates to the analysis of player tracking data in the gaming industry. More specifically, the present invention provides techniques for identifying relationships in player tracking data and customizing a game application, including presentation states and game states, according to the identified relationships. The techniques described herein are applicable to architectures for gaming machines such as slot machines and video poker machines.

The management and analysis of data has long been important to many industries. As such, many methodologies have been developed over the years that are oriented towards utilizing the relational aspects of collected data and data presentation for a variety of applications.

The gaming industry is among those industries where the analysis of collected data is important to catering to customers, thus affecting a company's bottom line. Within the gaming industry, data are collected as players play games on the casino floor. These data are commonly referred to as player tracking information. Player tracking information is often combined with other player information such as city/state, age, income, etc., to form player data relationships. Using these player data relationships, casinos can combine the data collected from tracking the game play of specific players and target those players with specific marketing campaigns organized in an attempt to increase revenue for the casino. However, conventional relational databases and the tools used to mine them are unable to take full advantage of the richness of the data in the typical player tracking system. In many cases, the amount of data to be mined is extremely large resulting in database queries that take an inordinate amount of time when searching for specific attributes.

Given the success of marketing and promotional activities based on such systems to date, there are significant incentives to develop data analysis techniques which can take advantage of this richness and more specifically target marketing and promotional resources while reducing the amount of time traditional relational searches take to mine the data of interest.

Another avenue for the gaming industry to increase revenue is to spur player interest in the games available at a casino. However, as would be clear from a survey of player tracking information, or simply a visit to a local casino, each player who visits a casino is a unique individual. Thus, a game or game feature that may be interesting to one player is not necessarily interesting to another player. However, similar interests can often be found among common demographics. For instance, a large proportion of females over 60 years of age can be found playing a certain game or game type, while a large proportion of men between the ages of 20 and 30 can be found playing another game. This difference in game preference may be attributable to the different stimuli presented by those games. The females over 60 may respond favorably to a game with certain images and music (e.g., colorful floral patterns and easy listening), while the men between 20 and 30 instead respond favorably to other images and music (e.g., strobe lights and hard rock). However, many conventional gaming machines providing games of chance do not take these different player preferences or attributes into account. The same games are presented at the machine for play regardless of the player's individual characteristics. Due to the wide variations among player personalities and preferences, only a certain percentage of the games presented at the gaming machine are successful in gaining and maintaining player interest among certain demographics.

Traditionally, player tracking databases collect large amounts of data on players. However, the player tracking data gathered in these databases is used for limited purposes. For instance, players are sometimes rated according to the player's theoretical win or the amounts won and lost by the players. Other player tracking information is used for general monitoring purposes, or even discarded. The potential for using player tracking information to affect a company's bottom line in a financially meaningful way has not been realized.

What is needed is a framework to leverage player tracking information in a manner to develop a more sophisticated knowledge of the player and, accordingly, present the player with a tailored gaming experience at the machine so as to increase and sustain player interest.

### SUMMARY OF THE INVENTION

Disclosed are methods, apparatus, and systems, including computer program products, implementing and using techniques for customizing a game application for a player to play a game of chance on a gaming machine.

According to the present invention, techniques are provided by which data relationships in a relational database can be more easily identified than through the use of previously available data mining techniques. According to various embodiments of the present invention, one or more differences in a set of attributes and/or attribute relationships associated with individuals or groups of individuals are identified and used to create new optimized groups and data relationships.

Thus, aspects of the present invention provide methods and apparatus for analyzing data in a relational database in which a plurality of attributes are stored for each of a plurality of individuals. The plurality of attributes includes at least one attribute relating to gaming behavior associated with the corresponding individual. Selected ones of the plurality of attributes associated with each of a first subset of the individuals are compared with the selected attributes associated with others of the first subset of individuals to determine at least one difference among the plurality of attributes according to which the first subset of individuals may be divided into further subsets of the individuals. Each of the individuals in the first subset has at least one of the plurality of attributes in common.

One aspect of the present invention provides a method for customizing a game application for a player to play a game of chance on a gaming machine. A plurality of attributes are provided. The attributes include at least one attribute relating to gaming behavior of associated individuals. Values of selected attributes associated with ones of a set of individuals are compared with values of the selected attributes associated with others of the individuals. This comparison is performed to determine at least one attribute difference representing a difference among the values of the attributes. A subset of the set of individuals is defined. Each of the individuals in the subset has the one attribute difference in common. Player identification information is received for the player. Responsive to receiving the player identification information, player attributes for the player are retrieved. Based on the retrieved player attributes for the player, it is determined that the player belongs to the subset of individuals. Attribute differences associated with the subset of individuals are obtained. An element of the game application is defined according to the obtained attribute difference.

Another aspect of the present invention provides a method for providing a customized game application for a player to play a game of chance on the gaming machine. The method uses an attribute difference among attributes relating to gaming behavior of associated individuals. The attribute difference is determined by comparing values of selected attributes associated with ones of a set of the individuals with the values of the selected attributes associated with others of the set of the individuals. A subset of the set of individuals is defined so that each of the individuals in the subset has the attribute difference in common. The method includes receiving player identification information for the player. Based on the received player identification information, it is determined that the player belongs to the subset of the individuals. The attribute difference associated with the subset of individuals is retrieved. An element of the game application is defined according to the obtained attribute difference. The defined element of the game application is provided for execution of the game application on the gaming machine, including output of the defined element for play of the game of chance.

Another aspect of the present invention provides a gaming machine capable of providing a customized game application for a player to play a game of chance using an attribute difference among attributes relating to gaming behavior of associated individuals. The attribute difference is determined by comparing values of selected attributes associated with ones of a set of the individuals with values of the selected attributes associated with others of the set of the individuals. The attribute difference represents a difference among the values of the plurality of attributes. A subset of the set of individuals is defined so that each of the individuals in the subset has the attribute difference in common. The gaming machine includes an interface capable of receiving player identification information for the player. A gaming controller including one or more processors is coupled to the interface and configured to: (1) retrieve player attributes for the player from the storage medium, responsive to the interface receiving player identification information; (2) determine based on the retrieved player attributes for the player that the player belongs to the subset of individuals; (3) obtain the attribute differences associated with the subset of individuals; (4) define an element of the game application according to the obtained at least one attribute difference; (5) execute the game application, including output of the defined element for play of the game of chance.

Yet another aspect of the present invention provides a data processing device in communication with the gaming machine over a data network and coupled to provide a customized game application for a player to play a game of chance on the gaming machine using an attribute difference among attributes relating to gaming behavior of associated individuals. The attribute difference is determined by comparing values of selected attributes associated with ones of a set of the individuals with values of the selected attributes associated with others of the set of the individuals. The attribute difference represents a difference among the values of the plurality of attributes. A subset of the set of individuals is defined so that each of the individuals in the subset have the attribute difference in common. The data processing device includes an interface capable of receiving player identification information for the player. At least one processor is coupled to the interface and configured to: (1) retrieve player attributes for the player from a storage medium, responsive to receiving the player identification information; (2) determine that the player belongs to the subset of individuals, based on the retrieved player attributes for the player; (3) obtain the attribute differences associated with the subset of individuals; (4) define an element of the game application according to the obtained attribute difference. The defined element of the game application is provided to the gaming machine for execution of the game application, including output of the defined element for play of the game of chance.

All of the foregoing methods and apparatus, along with other methods and apparatus of aspects of the present invention, may be implemented in software, firmware, hardware and combinations thereof. For example, the methods of aspects of the present invention may be implemented by computer programs embodied in machine-readable media and other products.

Aspects of the invention may be implemented by networked gaming machines, game servers and other such devices. These and other features and benefits of aspects of the invention will be described in more detail below with reference to the associated drawings.

### BRIEF DESCRIPTION OF THE DRAWINGS

FIG. 1 is a block diagram of a player tracking system in which one or more embodiments of the present invention may be practiced.

FIG. 2 is a block diagram of a player tracking unit for use with one or more embodiments of the present invention.

FIG. 3 is a flowchart illustrating a method performed in accordance with one embodiment of the present invention.

FIGS. 4A and 4B are diagrams illustrating relationships between various subgroups of individuals within a group of individuals, in accordance with one embodiment of the present invention.

FIGS. 5A and 5B are block diagrams of a gaming machine software architecture providing gaming software 500 for generating a game of chance 525 on a gaming machine, according to one embodiment of the present invention.

FIG. 6 is a block diagram of a presentation component in a presentation module that is used to manipulate a 3-D object in a model file, according to one embodiment of the present invention.

FIG. 7 is a flow chart of a method for presenting a presentation component on a gaming machine, performed in accordance with one embodiment of the present invention.

FIG. 8 is a flow chart of a method for generating a presentation component on a gaming machine, performed in accordance with one embodiment of the present invention.

FIG. 9 is a block diagram depicting game stages, states and corresponding presentation states, in accordance with one embodiment of the present invention.

FIG. 10 is a block diagram depicting interaction of a gaming operating system, a game flow logical unit and a game presentation logic unit as a function of time, in accordance with one embodiment of the present invention.

FIG. 11 is a flow chart depicting a method in a gaming operating system of playing a game on a gaming machine, in accordance with one embodiment of the present invention.

FIG. 12 is a flow chart depicting a method in a game flow software module of playing a game on a gaming machine, in accordance with one embodiment of the present invention.

FIG. 13 is a flow chart depicting a method in a game presentation software object of playing a game on a gaming machine, in accordance with one embodiment of the present invention.

FIG. 14 is a flow chart depicting a method of playing a game on a gaming machine using a plurality of gaming software modules, in accordance with one embodiment of the present invention.

FIG. 15 shows a block diagram of a system 1500 for customizing a game application to be executed on a gaming machine, constructed in accordance with one embodiment of the present invention.

FIG. 16 shows a flow diagram of a method 1600 for customizing a game application using attribute differences to implement a scenario-based gaming configuration, according to one embodiment of the present invention.

FIGS. 17A and 17B show a flow diagram of a method of customizing a game application at a gaming machine using identified attribute differences, performed in accordance with one embodiment of the present invention.

FIG. 18 shows a flow diagram of a method 1718 of customizing the game presentation, performed in accordance with one embodiment of the present invention.

FIG. 19 shows a state diagram 1900 illustrating a sequence of states for the execution of a game application, in accordance with one embodiment of the present invention.

In FIG. 20, a flow diagram of a method 1724 of game flow customization is shown, according to one embodiment of the present invention.

In FIG. 21, a diagram of a video gaming machine 2 constructed according to one embodiment of the present invention is shown.

FIG. 22 is a block diagram of a gaming system that may be used to implement one or more embodiments of the invention.

FIG. 23 is a block diagram of a data processing device such as a game server, constructed according to one embodiment of the present invention.

FIG. 24 shows a block diagram of components of a gaming system 2400 for providing game software licensing and downloads, constructed in accordance with one embodiment of the present invention.

### DETAILED DESCRIPTION

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. Moreover, numerous specific details are set forth below in order to provide a thorough understanding of the present invention. The present invention may be practiced without some or all of these specific details. In other instances, well known operations and components have not been described in detail in order not to obscure the present invention.

Embodiments of the present invention provide a framework for using player information to develop a sophisticated knowledge of the player and accordingly present the player with a customized gaming experience at the gaming machine. Methods and apparatus are provided for tailoring a game application at the gaming machine according to relational data derived from the player information. The game application can be customized to affect how the particular game is played or presented to the player.

Embodiments of the present invention provide methods and apparatus for optimizing large amounts of data collected for game players and presenting the optimized data to the gaming machine. Rather than sending to the gaming machine possibly hundreds of different attributes associated with a particular player, certain data can be sent as a relational set derived from a player group. A relational data set, also referred to herein as a player score, can be used to consolidate a vast amount of player data into a useable form which can be digested by the game application at the gaming machine. For instance, a polymorphic approach can be implemented to derive the relational data set. The relational data set includes one or more unique relations, also referred to herein as attribute differences.

When the gaming machine receives the relational data sets, the gaming machine can use the player score to enable a particular game flow of a game application to morph based on the player score used. The net result is that a single game application utilizing a plurality of attribute differences can function as many games. In another embodiment of the invention, a super play score is generated having a subset of a number of player elements.

Player tracking programs are becoming more and more popular in the gaming industry. Player tracking programs provide rewards to players that typically correspond to the player's level of patronage (e.g., to the player's playing frequency and/or total amount of game plays at a given casino). Player tracking rewards may be free meals, free lodging and/or free entertainment. These rewards may help to sustain a game player's interest in additional game play during a visit to a gaming establishment and may entice a player to visit a gaming establishment to partake in various gaming activities.

In general, player tracking programs may be applied to any game of chance offered at a gaming establishment. In particular, player tracking programs are very popular with players of mechanical slot gaming machines, video slot gaming machines, and table games. In a gaming machine, a player tracking program may be implemented using a player tracking unit associated with the gaming machine and in communication with a player tracking server.

Typically, when a game player wants to play a game on a gaming machine and utilize the player tracking services, a game player inserts a player tracking card, such as a magnetic striped card, into a card reader associated with the gaming machine. After the magnetic striped card has been so inserted, the player tracking unit associated with the machine may detect this event and receive certain identification information contained on the card. For example, a player's name, address, and player tracking account number encoded on the magnetic striped card may be received by the player tracking unit. In general, a player must provide identification information of some type to utilize player tracking services available on a gaming machine. For current player tracking programs, the most common approach for providing identification information is to issue a magnetic-striped card storing the necessary identification information to each player that wishes to participate in a given player tracking program.

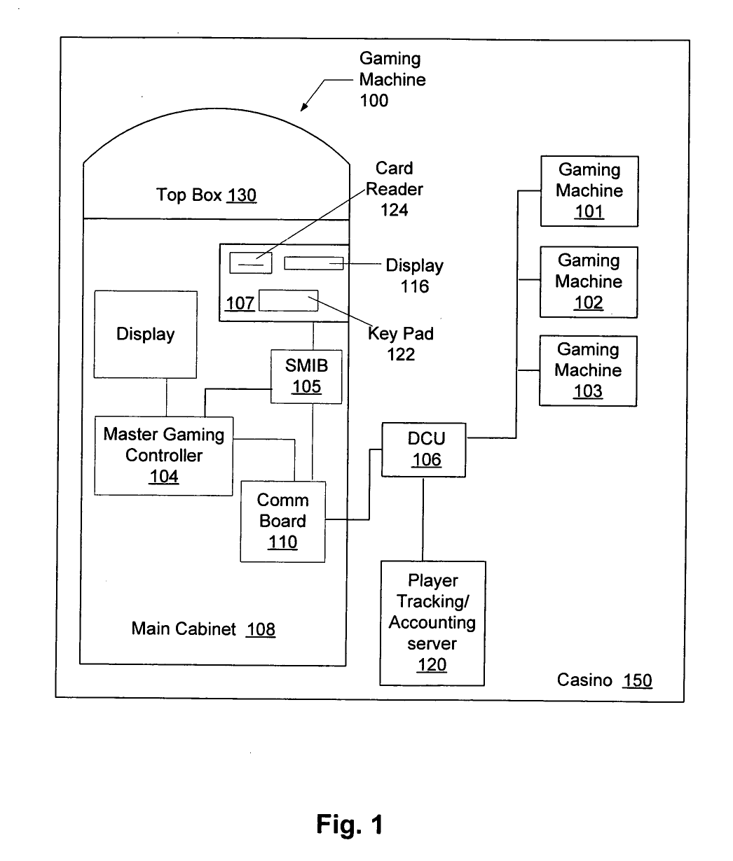

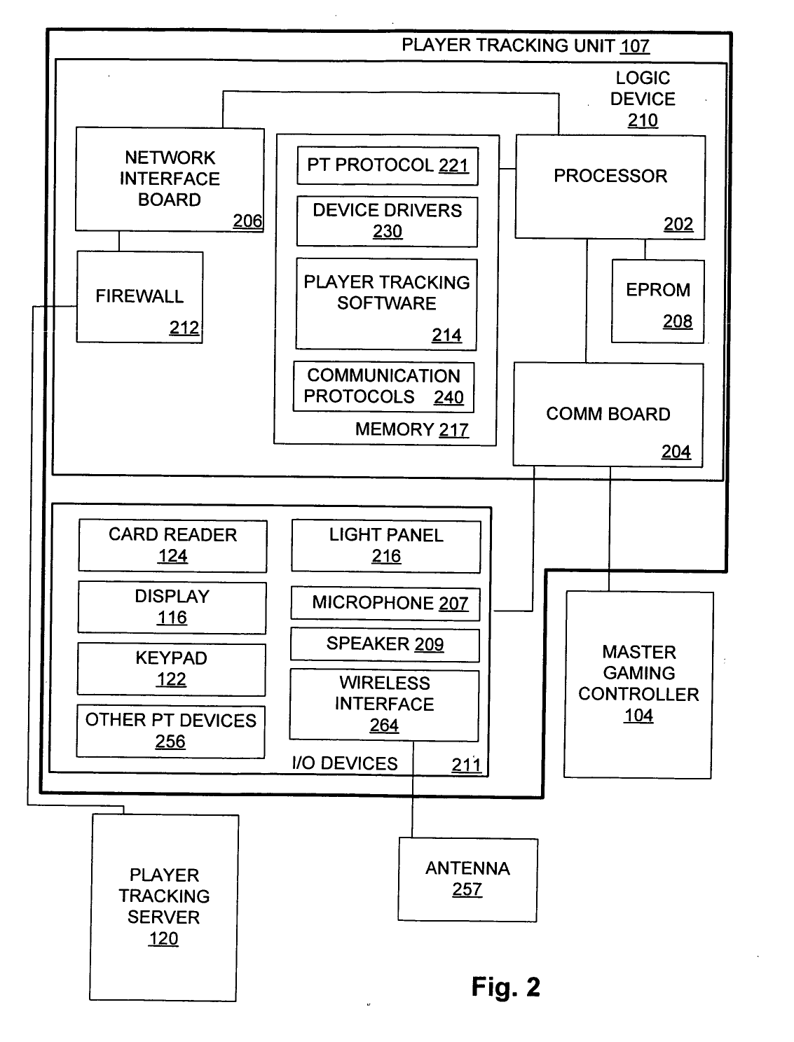

It will be understood that the specific systems and mechanisms by which player tracking data may be generated and collected vary widely and are not particularly relevant to the present invention. However, for illustrative purposes, an exemplary player tracking system in which various specific embodiments of the present invention may be implemented will now be described with reference to FIGS. 1 and 2. It should be understood at the outset that this player tracking system is described merely for illustrative purposes and that the present invention may be implemented using data generated by any of a wide variety of player tracking systems. Therefore, the scope of the invention should not be limited to the use of data generated by the player tracking system described.

FIG. 1 is a simplified block diagram of a gaming network including a number of gaming machines with player tracking units connected to a server providing player tracking services. In casino 150, gaming machines 100, 101, 102 and 103 are connected via the data collection unit (DCU) 106 to the player tracking/accounting server 120. The DCU 106, which, in a specific embodiment, may be connected to up to 32 player tracking units as part of a local network, consolidates the information gathered from player tracking units in gaming machines 100, 101, 102 and 103 and forwards the information to the player tracking account server 120. The player tracking account server is designed 1) to store player tracking account information such as information regarding a player's previous game play, and 2) to calculate player tracking points based on a player's game play that may be used as basis for providing rewards to the player.

In gaming machine 100 of casino 150, a player tracking unit 107 and slot machine interface board (SMIB) 105 are mounted within a main cabinet 108 of the gaming machine. A top box 130 is mounted on top of the main cabinet 108 of the gaming machine. In many types of gaming machines, the player tracking unit is mounted within the top box 130. Usually, player tracking units, such as 107, and SMIBs, such as 105, are manufactured as separate units before installation into a gaming machine, such as 100.

The player tracking unit 107 includes three player tracking devices, a card reader 124, a key pad 122, and a display 116, all mounted within the unit. The player tracking devices are used to input player tracking information that is needed to implement the player tracking program. The player tracking devices may be mounted in many different arrangements depending upon design constraints such as accessibility to the player, packaging constraints of a gaming machine and a configuration of a gaming machine. For instance, the player tracking devices may be mounted flush with a vertical surface in an upright gaming machine and may mounted flush with a horizontal in a table top gaming machine.

The player tracking unit 107 communicates with the player tracking server via the SMIB 105, a main communication board 110, and the data collection unit 106. The SMIB 105 allows the player tracking unit 107 to gather information from the gaming machine 100 such as an amount a player has wagered during a game play session. This information may be used by the player tracking server 120 to calculate player tracking points for the player. The player tracking unit 107 is usually connected to the master gaming controller 104 via a serial connection and communicates with the master gaming controller 104 using a serial communication protocol. The serial connection between the SMIB 105 and the master gaming controller 104 may be through the main communication board 110, through another intermediate device, or through a direct connection to the master gaming controller 104. As an example of a serial communication protocol, the master gaming controller 104 may employ a subset of the Slot Accounting System (SAS protocol) developed by International Game Technology of Reno, Nev., to communicate with the player tracking unit 107.

FIG. 2 is a block diagram of a player tracking unit for use with various embodiments of the present invention. Player tracking unit 107 is connected to a master gaming controller 104 on a gaming machine and a player tracking server 120. The player tracking unit 107 includes a logic device 210 enclosed in a logic device housing and a number of player tracking interface devices including a card reader 124, a display 116, a key pad 122, a light panel 216, a speaker 209, a microphone 207, a wireless interface 264, and other player tracking interface devices 256 enclosed in a device housing 211. The logic device 210 for the player tracking unit and the player tracking interface devices may be enclosed in a single housing or separate housings.

The logic device 210 may include a processor 202 for executing software allowing the player tracking unit to perform various player tracking functions such as communicating with the player tracking server 120, communicating with the master gaming controller 104, or operating the various peripheral devices such as the card reader 124, the display 116, the key pad 122 and the light panel 216. For instance, the logic device 210 may send messages containing player tracking information to the display 116. As another example, the logic device 210 may send commands to the light panel 216 to display a particular light pattern and to the speaker 209 to project a sound and convey audible game information. The logic device 210 may utilize a microprocessor and/or microcontrollers. For instance, the light panel 216 may include a microcontroller that converts signals from the processor 202 to voltage levels for one or more illumination devices. In one embodiment, application software for the player tracking unit 107 and configuration information for the player tracking unit may be stored in a memory device such as an EPROM 208, a non-volatile memory, a hard drive, or a flash memory.

The player tracking unit may include a memory 217 configured to store: 1) player tracking software 214 such as data collection software, 2) player tracking communication protocols 221 allowing the player tracking unit 107 to communicate with different types of player tracking servers, 3) device drivers 230 for many types of player tracking interface devices, 4) voice recognition software for receiving voice commands from the microphone 207, and 5) communication transport protocols 240 such as, for example, TCP/IP, USB, Firewire, IEEE 1394, or Bluetooth, allowing the player tracking unit to communicate with devices using these protocols, or allowing the logic device to communicate with different types of master gaming controllers (i.e., master gaming controllers using different types of communication protocols), such as 104. Typically, the master gaming controller, such as 104, communicates using a serial communication protocol. A few examples of serial communication protocols that may be used to communicate with the master gaming controller include but are not limited to USB, RS-232, and Netplex (a proprietary protocol developed by IGT, Reno, Nev.).

A plurality of device drivers 230 may be stored in memory 217 for each type of player tracking device. For example, device drivers for five different types of card readers, six different types of displays, and 8 different types of key pads may be stored in the memory 217. When one type of a particular peripheral device is exchanged for another type of the particular device, a new device driver may be loaded from the memory 217 by the processor 202 to allow communication with the device. For instance, one type of card reader in the player tracking unit 107 may be replaced with a second type of card reader where device drivers for both card readers are stored in the memory 217.

In some embodiments, the software units stored in the memory 217 may be upgraded as needed. For instance, when the memory 217 is a hard drive, new device drivers or new communication protocols may be uploaded to the memory from the master gaming controller 104, the player tracking server 120, or from some other external device. As another example, when the memory 217 is a CD/DVD drive containing a CD/DVD designed or configured to store the player tracking software 214, the device drivers 230, and other communication protocols 221 and 240, the software stored in the memory may be upgraded by replacing a first CD/DVD with a second CD/DVD. In yet another example, when the memory 217 uses one or more flash memory units designed or configured to store the player tracking software 214, the device drivers 230, and other communication protocols 221 and 240, the software stored in the flash memory units may be upgraded by replacing one or more flash memory units with new flash memory units storing the upgraded software.

In one embodiment of the present invention, a minimal set of player tracking software applications 214, communication protocols 240, player tracking communication protocols 221, and device drivers 230 may be stored in the memory 217. For instance, an operating system, a communication protocol allowing the player tracking unit 107 to communicate with a remote server such as the player tracking server 120 and one or more common player tracking applications may be stored in memory 217. When the player tracking unit is powered-up, the player tracking unit 107 may contact a remote server 120 and download specific player tracking software from the remote software. The downloaded software may include but is not limited to one or more particular player tracking applications that are supported by the remote server, particular device drivers, player tracking software upgrades, and a particular communication protocol supported by the remote server.

In some embodiments, the player tracking functions may be implemented by both the logic device 210 and the master gaming controller 104. For instance, the master gaming controller may execute voice recognition software to interpret voice commands input from the microphone 207. Thus, player tracking software such as the player tracking protocols may be stored on a memory located on the gaming machine that is separate from the player tracking unit. In some embodiments, the player tracking software stored in the memory in the gaming machine may be executed by the master gaming controller 104 in the gaming machine. In other embodiments, the player tracking software stored in the memory in the gaming machine may be executed by the logic device 210 in the player tracking unit.

The logic device 210 includes a network interface board 206 configured or designed to allow communication between the player tracking unit 107 and other remote devices such as the player tracking server residing on a local area networks such as a casino area network, a personal area network such as a piconet (e.g., using Bluetooth), or a wide area network such as the Internet. The network interface board 206 may allow wireless or wired communication with the remote devices. The network interface board may be connected to a firewall 212. The firewall may be hardware, software, or combinations of both that prevent illegal access of the gaming machine by an outside entity connected to the gaming machine. The internal firewall is designed to prevent someone such as a hacker from gaining illegal access to the player tracking unit or gaming machine and tampering with it in some manner. For instance, an illegal access may be an attempt to plant a program in the player tracking unit that alters the operation of the gaming machine allowing it to perform an unintended function.

The communication board 204 may be configured to allow communication between the logic device 210 and the player tracking interface devices including 124, 116, 122, 216, 207, 209, and 256 and to allow communication between the logic device 210 and the master gaming controller 104. The wireless interface 264 may be used to allow the player tracking unit and possibly the master gaming controller 104 to communicate with portable wireless devices or stationary devices using a wireless communication standard. The wireless interface 264 may be connected to an antenna 257. In some embodiments, the wireless interface 264 may be incorporated into the communication board 204. In addition, in some embodiments, the logic device 210 and the master gaming controller 104 may communicate using a non-proprietary standard wireless communication protocol such as Bluetooth or using a non-proprietary standard wired communication protocol such as USB, Firewire, IEEE 1394 and the like. In other embodiments, the logic device 210 and the master gaming controller may communicate using a proprietary communication protocol used by the manufacturer of the gaming machine.

The communication between the player tracking unit 107 and 1) the player tracking interface devices, 2) the master gaming controller 104, 3) the player tracking server 120 and 4) any other external or internal gaming devices may be encrypted. In one embodiment, the logic device 210 may poll the player tracking interface devices for information. For instance, the logic device 210 may poll the card reader 124 to determine when a card has been inserted into the card reader or may poll the key pad 122 to determine when a button key has been depressed. In some embodiments, the player tracking interface devices may contact the logic device 210 when a player tracking event such as a card being inserted into the card reader has occurred.

The logic device 210 may poll the master gaming controller 104 for game usage information. For instance, the logic device 210 may send a message to the master gaming controller 104 such as “coin-in.” The master gaming controller may respond to the “coin-in” message with an amount when credits are registered on the gaming machine.

The logic device 210, using an appropriate device driver, may send instructions to the various player tracking interface devices to perform specific operations. For instance, after a card has been inserted into the card reader 124, the processor logic device may send a “read card” instruction to the card reader, a “display message A” instruction to the display 116, and a “good luck” voice message to speaker 209. In addition, the logic device 210 may be configured to allow the master gaming controller 104 to send instructions to the player tracking interface devices via the logic device 210. As an example, after a card has been inserted into the card reader 124, the processor logic 210 may determine that the card is for a gaming application controlled by the master gaming controller 104 and send a message to the master gaming controller 104 indicating a card has been inserted into the card reader. In response, to the message from the logic device, the master gaming controller 104 may send a series of commands to the player tracking interface devices such as a “read card” instruction to the card reader 124, a flash light pattern “A” command to the light panel 216, and a “display message” instruction to the display 116 via the logic device 210. The instructions from the master gaming controller 104 to the player tracking interface devices may be obtained from gaming application software executed by the master gaming controller 104. The gaming application software may or may not be related to player tracking services.

The player tracking unit 107 may include one or more standard peripheral communication connections (not shown). The logic device 210 may be designed or configured to communicate with the master gaming controller 104 and the player tracking interface devices using a standard peripheral connection, such as an USB connector, and using a standard communication protocol, such as USB. The USB standard allows for a number of standard USB connectors that may be used with the present invention. The player tracking unit 107 may contain a hub connected to the peripheral communication connection and containing a plurality of peripheral communication connections.

The player tracking data generated and collected using the exemplary system of FIGS. 1 and 2 may include, for example, each player's name, age, geographical region, gender, income, frequency of play, favorite day to play, favorite time to play, average amount bet, speed of play, total amount played, game preference, entertainment preference, cuisine preference, beverage preference, birth date, etc. It should be noted that this list of attributes is not exclusive and that embodiments of the invention are contemplated which relate to or employ different combinations of these attributes as well as any additional attributes relating to a player's demographic profile or gaming behavior. In addition, the data analysis techniques described herein may be performed by any of a variety of computing systems and devices such as, for example, the player tracking account server 120 of FIGS. 1 and 2.

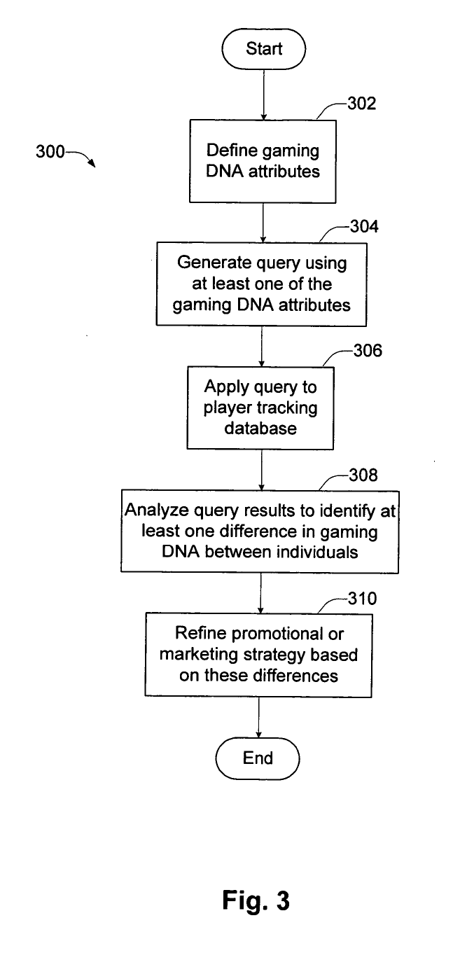

According to an exemplary embodiment represented by the flow chart of FIG. 3, a set of attributes and/or attribute relationships for a single individual which collectively define a sort of “gaming DNA” for the individuals in a player tracking system database are identified (302). The set of attributes and/or attribute relationships which makes up this gaming DNA may be any subset of the attributes stored in the system's player tracking database (examples given above), and any relationships between such attributes, and may vary from analysis to analysis. That is, as will become clear, the set of attributes and/or relationships defining the gaming DNA may be redefined each time the player tracking database is mined according to the techniques of the present invention.

As used herein, the term “attribute relationship” may include relationships of attributes to specific individuals as well as relationships between or among a set of attributes related to the individual. An exemplary set of attributes and some typical values or ranges of values associated therewith are shown in Table I. As noted above, this set of attributes is merely exemplary and represents a specific subset of all possible attributes which may be tracked in a player tracking system and which may be used to implement the data analysis techniques of the present invention. Similarly, the attribute values and ranges shown are only examples of the values and ranges that may be employed without departing from the scope of the invention.

TABLE I

| Attribute | Value/Range |
|---|---|
| Age | 21-35; 35-45; over 45 |
| Geographical Region | e.g., Washoe County, Carson, Tahoe . . . |
| Gender | Male or Female |
| Income | <25K; 25K-35K; 35K-50K . . . |
| Frequency of Play | 1-10 times/month; 1 time/week; every day . . . |
| Favorite Day to Play | Mon; Tue; Wed; Thu; Fri; Sat; Sun . . . |
| Favorite Time to Play | 6am-1pm; 1pm-7pm; 7pm-10pm . . . |
| Average Amount Bet | $1; $5; $10; $20; $50; $100 . . . |
| Total Amount Played | $0-100; $100-500; $500-1000 . . . |
| Game Preference | Little Green Men; Texas Tea; Neon Nights . . . |
| Cuisine Preference | Italian; Chinese; Sea Food . . . |
| Music Preference | Rock'n'Roll; Blues; Classical; Jazz . . . |

Regardless of what attributes values and attribute relationships are used, once the gaming DNA attributes and/or relationships for a particular analysis are selected, a particular value or set of values for one or more of these attributes is used to form a traditional query (304) which is then applied to the player tracking database to retrieve a first subset of the specific individuals represented in the database corresponding to that value or set of values and attribute relationships (306). For example, a query might be formulated to identify all males over the age of 40 who engage in gaming activity at least 10 times per month and frequently play on Saturday nights. Under traditional marketing or promotional techniques, such a query would typically be formulated into a group with an a priori marketing plan targeted to individuals corresponding to such a demographic. According to the present invention, further relationships in the data may be identified which can facilitate more accurate, efficient, and effective targeting of marketing and promotional resources.

For example, a user may wish to do a query on attribute differences for the group identified above, i.e., all males over the age of 40 who engage in gaming activity at least 10 times per month and frequently play on Saturday nights. As will be described, these attribute differences are then used to create subgroups which may be further evaluated for differences. For example, 90% of the main group may play on 25 cent gaming machines. This forms a subgroup which in turn may form other subgroups based on further differences, e.g., only 5% of the subgroup plays between 2 am and 4 am.

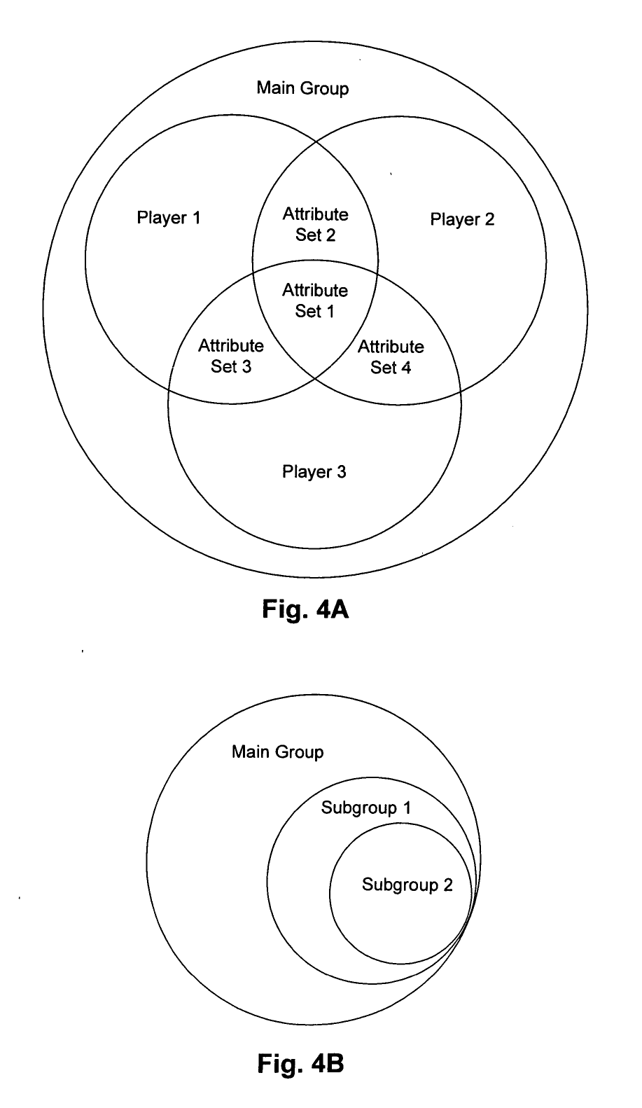

FIG. 4A illustrates how each player in the main player group has one or more attributes in common (e.g., Attribute Set 1) with all other players in the group, as well as other attributes (e.g., Attribute Sets 2, 3, and 4) which are held in common with only certain other players. That is, distinct subgroups may be identified by such commonalties. However, instead of using traditional queries, the present invention more efficiently identifies such subgroups within the main group and within other subgroups (see FIG. 4B) with reference to the differences between the gaming DNA of the players in the main group or subgroup.

Referring back to FIG. 3 and according to a specific embodiment, the gaming DNA of the individuals identified in 306 are analyzed to identify one or more differences by which this first subset of individuals may be further subdivided (308). Each such difference may be referred to herein as a single relational polymorphism or SRP.

The phrase “single relational” represents the attribute relationships that exist for a given individual. The term polymorphism is used in traditional object oriented programming to mean the way in which something is implemented can be changed or extended without effecting the mechanisms that depend on the fact that the action is actually performed. In the field of genetics, Single Nucleotide Polymorphisms (or SNPs) are the different nucleotides detected in a human DNA sequence comprising four nucleotides; compare two sequences, position by position, and wherever you come across different nucleotides at the same position, an SNP has been detected. The phrase “Single Relational Polymorphism” as used herein represents a single relationship of data attributes which is different, or has changed, for an individual or subset of individuals from that set of data attributes that exists for a larger group or superset of individuals.

According to a specific embodiment of the invention, this analysis involves comparing the gaming DNA of each of selected individuals identified in the original query to others in the same group and placing the individuals into further subsets based on those specific differences identified. According to one embodiment, only a specified set of the attributes are compared, e.g., compare and group according to cuisine preference. According to another embodiment, all of the attributes are compared. According to yet another embodiment, only attributes not employed in the original query are compared. According to various embodiments, the differences between attribute relationships for specific individuals within a group are used to create a subgroup. The subgroup may or may not be evaluated for further differences, i.e., to create further subgroups.

As an example, consider the following profiles (or gaming DNA) which are included in the results of the sample query described above with reference to 304 and 306:

TABLE II

| Gaming DNA Type 1 | Gaming DNA Type 2 |
|---|---|
| Attribute Values | Attribute Values |
| Male | Male |
| Over age 40 | Over age 40 |
| Play over 10 times/month | Play over 10 times/month |
| Play on Saturday nights | Play on Saturday nights |
| Total amount played $100-$200 | Total amount played $500-$600 |
| Chinese food preference | Italian food preference |
| Rock'n'Roll music preference | Blues music preference |

Both gaming DNA types 1 and 2 share the attribute values of the original query, i.e., males over age 40 who play at least 10 times per month and on Saturday nights. However, there are some key differences, i.e., single relational polymorphisms, which distinguish the individuals corresponding to these profiles in some respects that, as will be discussed, can be significant from a marketing or promotional perspective. For example, the individuals corresponding to the different gaming DNA types differ in the total amount played ($100-$200 vs. $500-$600), the cuisine preference (Chinese vs. Italian), and the music preference (Rock'n'Roll vs. the Blues). The significance of such differences with regard to the allocation of marketing and promotional resources will become apparent.

It should be noted, that these differences could be identified using the trial and error approach of traditional data mining techniques, e.g., numerous successive queries or sorting by each of the other possible attributes. The inefficiencies inherent in such an approach are manifest. By contrast, the present invention provides a more efficient way to identify these differences by allowing comparison across a specified set of parameters, i.e., the gaming DNA, thus going beyond the relatively limited original query without requiring the hit-and-miss approach.

The marketing or promotional strategy upon which the original query in 304 was based may then be refined based on any of the SRPs identified (310). For example, referring again to Table II, a casino might be inclined to give preferential treatment to customers corresponding to gaming DNA type 2 because of their higher level of patronage. In addition, promotional offerings such as free dinners and shows can be more specifically tailored for each customer, e.g., an Italian dinner or Blues show for type 2 individuals versus a Chinese dinner or a Rock'n'Roll show for a type 1 individual.

U.S. Pat. No. 6,902,481, Breckner et al., titled “DECOUPLING OF THE GRAPHICAL PRESENTATION OF A GAME FROM THE PRESENTATION LOGIC” (Attorney Docket No. IGT1P081), which is hereby incorporated by reference, describes a gaming machine designed to execute a modular software architecture. The gaming machine allows a game presentation to be customized using presentation modules. The presentation modules, which may be executed on the gaming machine, include logic for generating presentation components that may stimulate a game player's senses while playing a game of chance on the gaming machine. The presentation modules in conjunction with game flow logic and presentation state logic may be used to generate a game of chance on a gaming machine. The presentation modules may be decoupled from game flow logic and presentation state logic on the gaming machine using one or more APIs. Thus, using the same game flow logic and presentation state logic with different presentation modules, many different games of chance may be provided for game play on the gaming machine.

A gaming machine constructed according to one embodiment of the present invention may be generally characterized as comprising: 1) a master gaming controller designed to generate a game of chance played on the gaming machine by executing a plurality of gaming software modules; 2) a memory device storing the plurality of gaming software modules; 3) a gaming operating system comprising logic to load and unload gaming software modules into a RAM from the memory device and control the play of the game of chance; 4) a presentation logic module comprising logic to generate a presentation for the game of chance on the gaming machine; and 5) one or more presentation modules comprising logic to generate a presentation component used as part of the presentation for the game of chance.

In particular embodiments, the one or more presentation modules may communicate with the one or more gaming software modules via an application program interface. The application program interface may be used to communicate sequence events used to control the play of the game of chance. The gaming software module may be a game flow logic software module that generates a sequence of game states used to play the game of chance. The game of chance may be selected from slot games, poker games, pachinko games, multiple hand poker games, pai-gow poker games, black jack games, keno games, bingo games, roulette games, craps games, checkers, board games and card games.

In particular embodiments, the presentation of the game of chance may comprise a plurality of presentation states where the presentation logic module further comprises logic that is used to determine one or more presentation components that are used in each presentation state. In general, the presentation component may be designed to stimulate a game player's sight, hearing, touch, smell, taste and combinations thereof. In particular, the presentation component may be at least one of a graphical component, an audio component, a gaming device component and combinations thereof. The presentation component may be presented on a gaming device where the gaming device is at least one of a display screen, an audio output device, a lighting device, a bonus wheel, a mechanical reel, a tactile feedback device and a scent generation device.

In other embodiments, the presentation module may further comprise logic for at least one method sequence that generates a presentation component. The method sequence may comprise one or more input parameters that are used to modify the presentation component generated by the method sequence. Therefore, the method sequence may be used with a first set of input parameters to generate a first presentation component and the method sequence may be used with a second set of input parameters to generate a second presentation component where the first presentation sequence and the second presentation sequence are generated using the same method sequence logic.

The method sequence may operate on a model file to generate the presentation component where the model file comprises a graphical component, an audio component, a gaming device component and combinations thereof. Therefore, the method sequence may operate on a first model file to generate a first presentation component and the method sequence may operate on a second model file to generate a second presentation component where the first presentation component and second presentation component are generated using the same method sequence logic. The method sequence may be used to change a property of a graphical object displayed on a display screen of the gaming machine where the property is a color, a size, a position, a shading and a texture. The method sequence may also be used to generate an animation sequence. For example, the method sequence may be used to generate a sequence of video frames that provide an animated transition between a first video frame and a second video frame.

A method of generating a presentation component used in a play of a game of chance on a gaming machine can be provided. In one embodiment, the method includes: 1) receiving a request to generate a presentation component for a presentation state in the game of chance played on the gaming machine; 2) executing one or more method sequences to generate the presentation component; 3) displaying the presentation component on a gaming device; and 4) communicating with gaming software modules via one or more application program interfaces. The gaming software module may be one or more of 1) a gaming operating system software module that loads and unloads gaming software modules into the RAM from a memory device and controls the play of the game of chance, 2) a game flow software module that generates the game flow for the game of chance and 3 presentation state logic module that determines the presentation components that are used in the presentation state where the presentation state may comprise a plurality of presentation substates.

A method of providing a presentation component used in a play of a game of chance on a gaming machine can be provided. In one embodiment, the method includes: 1) providing a method sequence template comprising one or more method sequences; 2) selecting a model file to be operated on by the method sequences; and 3) executing the method sequences to generate a presentation component used in a presentation of the game of chance on the gaming machine.

A presentation design system for designing presentation components for a game of chance on a gaming machine can be provided. In one embodiment, the presentation design system includes: 1) a presentation module design interface for generating a presentation module for a game of chance; a gaming simulator that generates: i) game states and presentation states for the game of chance, and ii) presentation components for each presentation state wherein at least one presentation component is generated using the presentation module; and 2) a presentation interface for outputting the presentation components.

In particular embodiments, the presentation design system may also include graphical design software for generating a graphical model used in the presentation module. The presentation module may comprise one or more model files and script files with one or more method sequences that operate the one or more model files.

Some embodiments of the invention pertain to computer program products including a machine-readable medium on which is stored program instructions for implementing any of the methods described above. Any of the methods of this invention may be represented as program instructions and/or data structures, databases, etc. that can be provided on such computer readable media. Yet another embodiment of the present invention is a system for delivering computer readable instructions, such as transmission, over a signal transmission medium, of signals representative of instructions for remotely administering any of the methods as described herein.

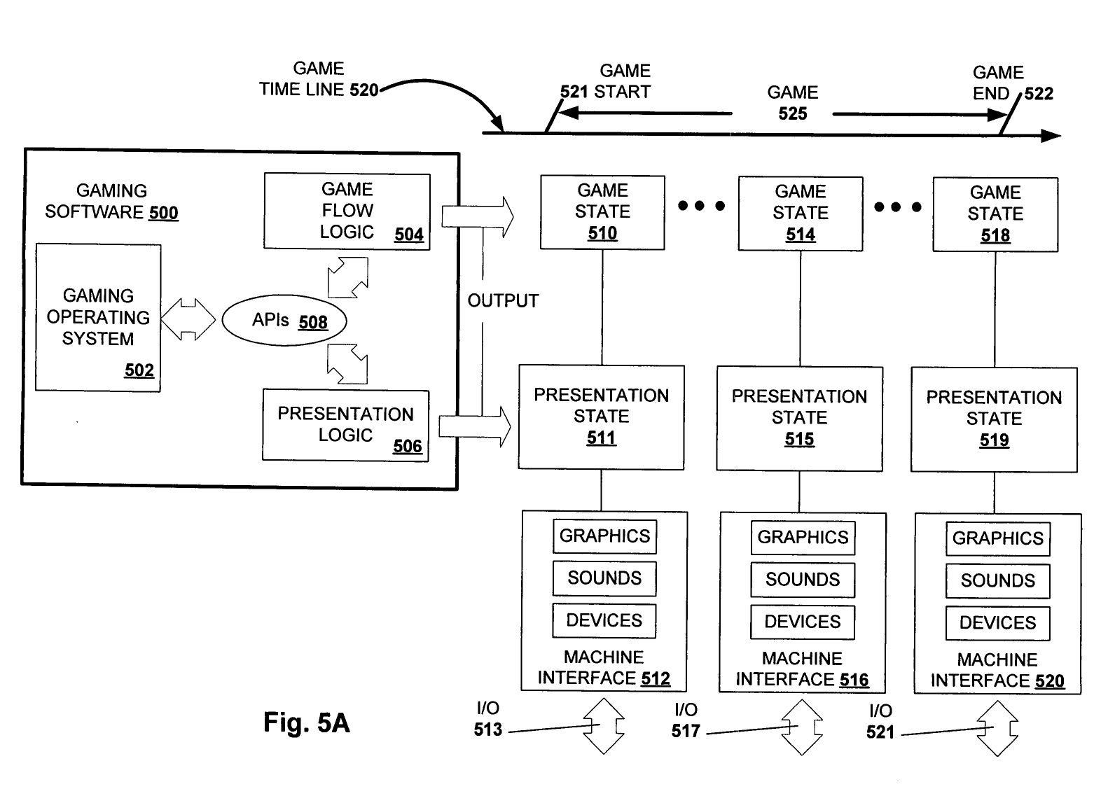

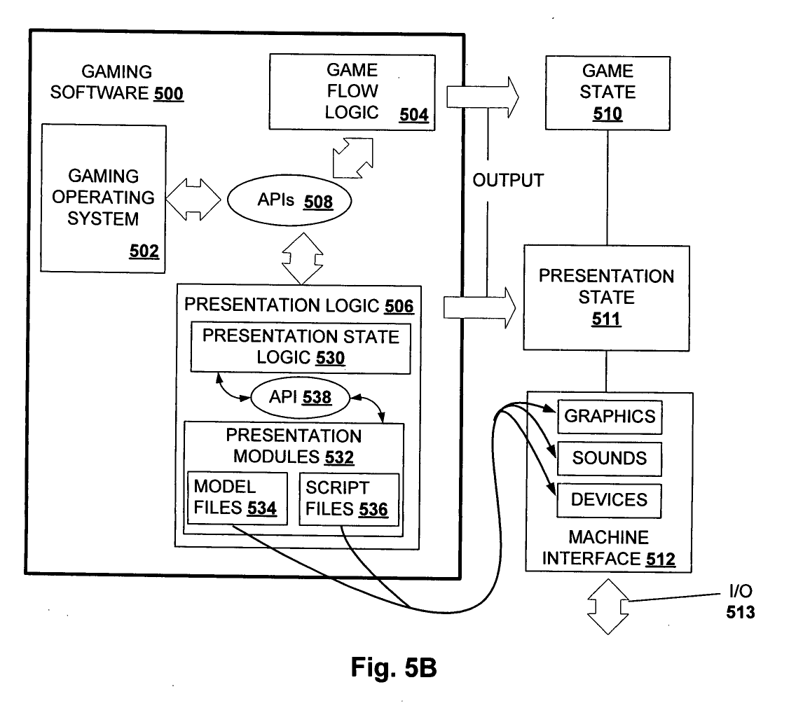

FIGS. 5A and 5B are block diagrams of a gaming machine software architecture providing gaming software 500 for generating a game of chance 525 on a gaming machine for one embodiment of the present invention. The presentation logic 506 may be used to generate graphical output, audio output and gaming device output for presenting the game of chance 525 on the gaming machine. The presentation logic 506 (see FIG. 5B) may be decoupled into two parts: presentation state logic 530 and presentation module logic 532. The presentation state logic 530 is used to determine what graphical components, sound patterns and gaming devices are used to present a game play on the gaming machine as a function of time. The presentation modules 532 may be used to describe, in a modular manner, particular implementations of graphical components, sound patterns and gaming devices that are used to present the game play to a game player playing the gaming machine. The presentation state logic 530 and the presentation modules 532 are generally decoupled from one another and may communicate via one or more APIs 538.

Provided are: 1) an input and format structure for presentation modules that allow animation sequences and other components of the game outcome presentation to be easily modified and 2) a modular software architecture that allows one presentation module to be exchanged with another presentation module. As an example, in response to a touch screen input button being depressed on the display screen of a gaming machine, the presentation state logic 530 may determine that an animation of the input button is required. The presentation state logic 530 may communicate, via APIs, 538 with one of the presentation modules 532 and request the presentation module to generate an animation of the input button. Many different animation sequences may be used to animate the button. Thus, in one example, the presentation state logic 530 may command a first presentation module to generate a first animation sequence, which shows an input button being depressed. In another case, the presentation state logic 530 may instead command a second presentation module to generate an animation sequence, which shows an input button being depressed differently than the input button animated in the first presentation module. Details of the presentation modules and their interactions with the other gaming software components are described in the following paragraphs.

The gaming machine software architecture provides gaming software 500 that is divided into a plurality of gaming software modules. The gaming software modules may communicate with one another via application program interfaces. The logical functions performed in each gaming software module and the application program interfaces used to communicate with each gaming software module may be defined in many different ways. Thus, the examples of gaming software modules and the examples of application program interfaces in the present invention are presented for illustrative purposes only and the present invention is not limited to the gaming software modules and application program interfaces described herein.

In general, APIs let application programmers use functions of a software module without having to directly keep track of all the logic details within the software module used to perform the functions. Thus, the inner working of a software module with a well-defined API may be opaque or a “black box” to the application programmer. However, with knowledge of the API, the application programmer knows that a particular output or set of outputs of the software module, which are defined by the API, may be obtained by specifying an input or set of inputs specified by the API.

Typically, APIs describe all of key transactions and associated processing necessary to perform a particular function. For example, functions of a particular presentation module, such as animating a button being depressed, may be described as part of an API for the presentation module. The APIs 538 for the presentation modules 532 may be defined in definition files installed with the game 525. An API may be considered analogous to a device driver in that it provides a way for an application to use a hardware subsystem without having to know every detail of the hardware's operation. Using a well-defined APIs, the logic functions of various gaming software modules may be decoupled.

In FIGS. 5A and 5B, three gaming software modules, a gaming Operating System (OS) 502, a presentation logic module 506 and a game flow logic module 506 used to present a game of chance 525 on a gaming machine are shown. The gaming operating system 502, the presentation logic module 506 and the game flow logic module 504 may be decoupled from one another and may communicate with one another via a number of application program interfaces 508. The gaming OS 502 may load different combination of game flow logic modules 504 and presentation logic modules 506 to play different games of chance. For instance, to play two different games of chance, the game OS 502 may load a first game flow logic module and a first presentation logic module to enable play of a first game and then may load a second presentation logic module and use it with the first game flow logic module to enable play of a second game. As another example, to play two different games of chance, the game OS 502 may load a first game flow logic module and a first presentation logic module to enable play of a first game and then may load a second game flow logic module and a second presentation logic module to enable play of a second game. Details of the APIs 508 and the gaming software 500 including the Game OS 502, the game flow logic 504 and the presentation logic 506, are described in co-pending and commonly assigned U.S. application Ser. No. 10/040,739, (Attorney Docket No. IGT P078), filed on Jan. 3, 2002, by LeMay et al, titled, “Game Development Architecture that Decouples the Game Logic from the Graphics Logic,” which is hereby incorporated by reference.

The Gaming OS 502 comprises logic for core machine-wide functionality. It may control the mainline flow as well as critical information such as meters, money, device status, tilts and configuration used to play a game of chance on a gaming machine. Further, it may be used to load and unload gaming software modules, such as the game flow logic 504 and the presentation logic 506, from a mass storage device on the gaming machine into RAM for execution as processes on the gaming machine. The gaming OS 502 may also maintain a directory structure, monitor the status of processes and schedule the processes for execution.

The game flow logic module 504 comprises the logic and the state machine to drive the game 525. The game flow logic may include: 1) logic for generating a game flow comprising a sequence of game states, 2) logic for setting configuration parameters on the gaming machine, 3) logic for storing critical information to a non-volatile memory device on the gaming machine and 4) logic for communicating with other gaming software modules via one or more APIs. In particular, after game play has been initiated on the gaming machine, the game flow logic may determine a game outcome and may generate a number of game states used in presenting the game outcome to a player on the gaming machine.

In general, gaming machines include hardware and methods for recovering from operational abnormalities such as power failures, device failures and tilts. Thus, the gaming machine software logic and the game flow logic 504 may be designed to generate a series of game states where critical game data generated during each game state is stored in a non-volatile memory device. The gaming machine does not advance to the next game state in the sequence of game states used to present a game 525 until it is confirmed that the critical game data for the current game state has been stored in the non-volatile memory device. The game OS 502 may verify that the critical game data generated during each game state has been stored to non-volatile memory. As an example, when the game flow logic module 504 generates an outcome of a game of chance in a game state, such as 510, the gaming flow logic module 504 does not advance to the next logical game state in the game flow, such as 514, until game information regarding the game outcome has been stored to the non-volatile memory device. Since a sequence of game states are generated in the gaming software modules as part of a game flow, the gaming machine is often referred to as a state machine.

In FIG. 5A, a game timeline 520 for a game of chance 525 is shown. A gaming event, such as a player inputting credits into the gaming machine, may start game play 525 on the gaming machine. Another gaming event, such as a conclusion to an award presentation may end the game 522. Between the game start 521 and game end 522, as described above, the game flow logic may generate a sequence of game states, such as 510, 514 and 518, that are used to play the game of chance 525. A few examples of game states may include but are not limited to: 1) determining a game outcome, 2) directing the presentation logic 506 to present the game outcome to player, 3) determining a bonus game outcome, 4) directing the presentation logic 506 to present the bonus game to the player and 5) directing the presentation logic to present an award to the game to the player.

The presentation logic module 506 may produce all of the player display and feedback for a given game of chance 525. Thus, for each game state, the presentation logic 506 may generate a corresponding presentation state (e.g., presentation states 511, 515 and 519 which correspond to game states 510, 514 and 518, respectively) that provides output to the player and allows for certain inputs by the player. In each presentation state, a combination of gaming devices on the gaming machine may be operated in a particular manner as described in the presentation state logic 506. For instance, when game state 510 is an award outcome state, the presentation state 511 may include but are not limited to: 1) animations on one or more display screens on the gaming machine, 2) patterns of lights on various lighting units located on the gaming machine and 3) audio outputs from audio devices located on the gaming machine. Other gaming devices on the gaming machine such as, bonus wheels and mechanical reels, may also be operated during a presentation state.

The presentation logic 506 may generate a plurality of presentation substates as part of each presentation state. For instance, the presentation state determined by the presentation state logic in a first game of chance may include a presentation substate for a first animation, a presentation substate for a second animation and a third presentation substate for output on a gaming device that generates tactile sensations. In a second game of chance, the presentation state generated by the presentation state logic may be the same as the first game of chance. However, the presentation substates for the second game of chance may be different. For instance, the presentation substates for the second game of chance may include a presentation substate for an animation and a second presentation substate for output on a gaming device that provides scents.

The number of presentation substates used in a particular presentation may be varied. Thus, a game presentation may be customized by changing the presentation substates used in each presentation state where the presentation substates may generate various presentation components. The presentation substates may be described in the presentation modules 532. Thus, presentation modules describing different presentation substates may be incorporated into a game of chance to change the game outcome presentation while allowing the same presentation substate logic 530 to be re-used.

In addition, the presentation state generated by the presentation logic 506 may allow gaming information for a particular game state to be displayed. For instance, the presentation logic module 506 may receive from the gaming OS 502 gaming information indicating a credit has been deposited in the gaming machine and a command to update the displays. After receiving the information indicating the credit has been deposited, the presentation logic 506 may update a credit meter display on the display screen to reflect the additional credit added to the gaming machine.

The gaming devices operated in each presentation state and presentation substate comprise a machine interface that allows the player to receive gaming information from the gaming machine and to input information into the gaming machine. As the presentation states change, the machine interface, such as 512, 516 and 520, may change and different I/O events, such as 513, 517, 521, may be possible. For instance, when a player deposits credits into the gaming machine, a number touch screen buttons may be activated for the machine interface 512 allowing a player to make a wager and start a game. Thus, I/O 513 may include but is not limited to 1) the player touching a touch screen button to make a wager for the game 525, 2) the player touching a touch screen button to make a wager and start the game at the same time and 3) the player viewing the credits available for a wager. After making a wager and starting the game using machine interface 512, in game state 514, the player may be presented with a game outcome presentation using machine interface 516. The I/O 517 on the machine interface 516 may include output of various animations, sounds and light patterns. However, for machine interface 516, player input devices, such as touch screen buttons, may not be enabled.

The presentation components of a given presentation state may include but are not limited to graphical components, sound components, scent components, tactile feedback components and gaming device components to be activated on the machine interface 512. For example, presentation state 511 may include the following presentation components: 1) animate input button, 2) animate reels, 3) play sound A for 2 seconds and then play sound B for 1 second, 4) flash light pattern A for two seconds on lighting device A and 5) spin bonus wheel. The presentation modules 532 may be used to specify an implementation of one or more presentation components used on the machine interface for a given presentation state such as the presentation state 511 described above. Further, the presentation modules may be parameterized to allow some output of the presentation module to be easily changed.

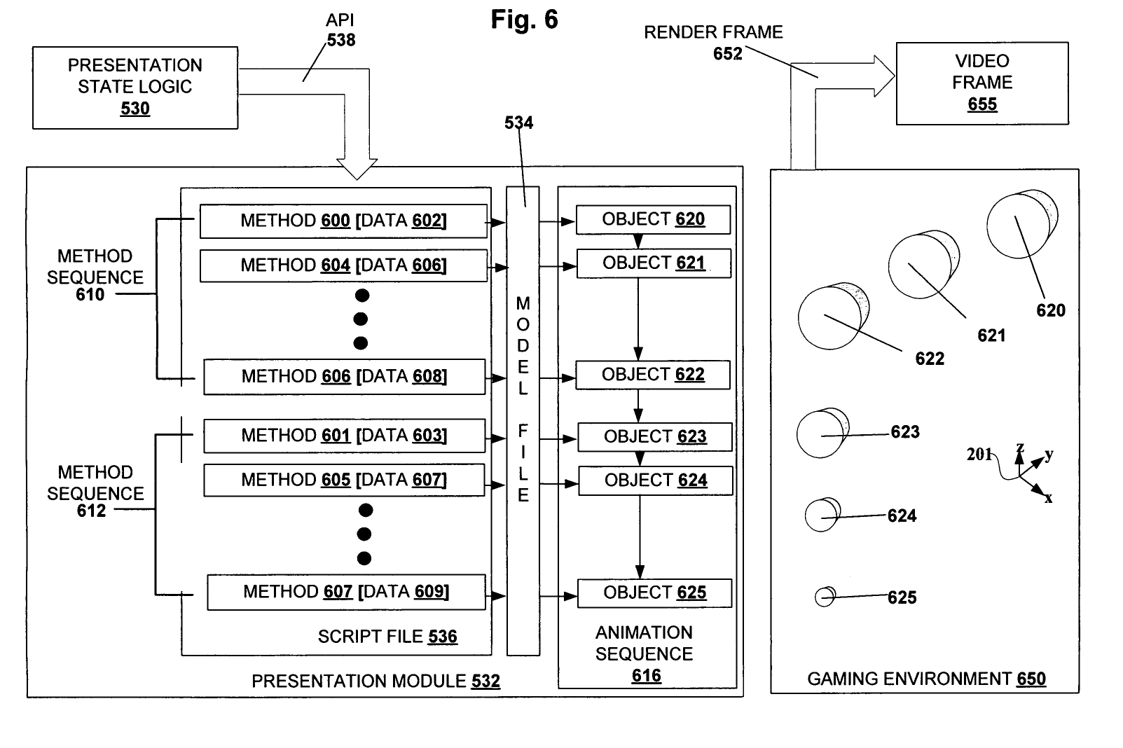

Some examples of presentation modules that implement presentation components are described as follows. A presentation module may be designed to generate an animation sequence of a spinning reel, which is displayed on a display screen on the machine interface 512. The presentation module may include a 3-D model of a reel stored as a model file 534. A series of methods stored in one of the script files 536 may be used to generate and control the animation of the reel. For instance, the methods may direct the reel to rotate, change size and translate around the screen. The methods may be parameterized (see FIG. 6) to enable a game developer to easily change aspects of the animation. For example, numerical inputs to the methods in the script file that operate on the reel may be used to change a rate of rotation of the reel, the size of the reel and its position on the screen. An API which allows the presentation logic 530 to activate the animation sequence in the presentation module may be stored in a definition file (not shown).

As another example of a presentation module, a presentation module may be designed to generate an audio sequence for a game outcome presentation on the machine interface 512. The audio sequence may be output on one or more audio devices on the gaming machine. The presentation module may include one or more model files comprising one or more sound files and a script file with a series of methods that control output of the sounds in the sound files. The methods may be parameterized to allow a game developer to easily change aspects of the audio sequence. For instance, the methods may include inputs enabling a game developer to change a length of a time a sound in a sound file is played, a volume of the sound and an output device for the sound. An API which allows the presentation logic 530 to activate the audio sequence in the presentation module may be stored in a definition file (not shown).

In yet another example of a presentation module, a presentation module may be designed to generate an activation sequence for a gaming device, such as a mechanical bonus wheel or a light panel, used in a game outcome presentation or a bonus game outcome presentation on the machine interface 512. The presentation module may include a model file with one or more device drivers for the gaming device and a script file with a series of methods that control the activation of the gaming device via the device drivers. The device drivers model the behavior of the gaming device. Again, the methods may be parameterized to allow a game developer to easily change aspects of the activation sequence for the gaming device. For instance, for a bonus wheel, the methods may include inputs enabling a game developer to change a rate at which the bonus wheel spins, a length of time the wheel spins and a final position of the wheel. As another example, for a light panel, the methods may include inputs enabling a game developer to change a length of times the panel is activated and a light pattern for the light panel. An API which allows the presentation logic 530 to activate the activation sequence in the presentation module may be stored in a definition file (not shown).

When decoupled from the game flow logic 504, the presentation logic 506 makes no assumptions about game flow which means it does not assume the order of states or the logic that will be needed to determine the next state. The presentation logic 506 may, however, control flow by making the game flow logic 504 wait for the current presentation state (e.g., animation, audio output, etc.) to complete. Thus, for some game states, the game flow logic 504 may not advance to the next game state in the game flow until, it receives an acknowledgement from the presentation logic 506 that a current presentation sequence has been completed. Since the presentation modules 532 may be used to generate presentation sequences, logic for notifying the presentation state logic 530 that a presentation sequence generated by a presentation module is complete may be included in one of the script files of the presentation module.

When the gaming software architecture provides a plurality of gaming software modules that communicate via well-defined application program interfaces, gaming software developers may independently develop gaming software modules that are compatible with the defined application program interface without a direct knowledge of the logic used in related gaming software modules. For instance, a single game flow logic module 504 may be used with many different types of presentation logic modules 506 to generate different game themes and styles. Thus, with knowledge of the game flow logic APIs and gaming OS logic APIs, the developer may develop a game presentation without direct knowledge of the logic within the game flow logic module 504 and the gaming OS 502. The presentation modules 532 further decouple the game development process. With knowledge of the presentation logic APIs 538, a game developer may develop a presentation component, such as an animation sequence, using a presentation module without the direct knowledge of the presentation state logic 530 that is used to generate a presentation state requiring the animation sequence. Details of developing presentation components that may be applied with the present invention are described in co-pending U.S. application Ser. No. 09/910,507, filed Jul. 19, 2001, by Beaulieu et al., and titled “Gaming Method and Gaming Apparatus with In-Game Player Stimulation,” which is hereby incorporated by reference.

An advantage of decoupling the gaming software modules using APIs may be a faster software development and approval process. For instance, when a developer can develop a new game by generating only a new presentation logic module 506, the game development process is faster because much less code has to be written. Also, with presentation state logic 530 decoupled from implementation of the presentation state, the development of the presentation logic module 506 may be even faster because the presentation states for a game may be changed by altering the presentation modules 532 without changing the presentation state logic 530. In addition, if the APIs can be shown to be very fault tolerant (e.g., a particular software module will not produce undetectable erroneous results when given incorrect data via an API), then only new or modified gaming software modules installed on a gaming machine, such as a presentation logic module 506 for a new game, may have to be submitted for approval to a gaming jurisdiction prior to installation on the gaming machine. Previously approved gaming software that may be used in conjunction with new or modified gaming software module to present a game of chance, such as a previously approved game flow logic module 506 or a previously approved gaming OS 502, may not have to be resubmitted for approval. Since the amount of code submitted for approval may be less, the approval process may be streamlined. Currently, since most games installed on gaming machines are monolithic in nature with a single executable, any changes to a game for any reason requires all of the gaming software to be submitted for approval which is usually very time consuming.

FIG. 6 is a block diagram of a presentation component in a presentation module which is used to manipulate a 3-D object in a model file for one embodiment of the present invention. In FIG. 6, an example of a portion of an animation sequence is described for illustrative purposes only. Many different types of animation sequences are possible with the present invention and the present invention is not limited to the example in FIG. 6.

The presentation state logic 530 (see FIGS. 5A and 5B) may send a request to the presentation module 532, via API 538, to generate an animation sequence 616, such as animate input button. As part of the animation sequence, the presentation module 532 may execute a script file 536 comprising two method sequences 610 and 612. In this example, method sequence 610 is used to move a cylindrical 3-D object, described in a model file 534, in a 3-D gaming environment 650 with coordinates 201. Method sequence 612 is used to scale and move the cylindrical 3-D object, described in the model file 534, in the 3-D gaming environment 650.

A script file 536 may comprise a plurality of method sequences. The method sequences may operate on one or more 3-D objects described in a model file. For instance, a script file may comprise a first method sequence that operates on a first 3-D object and a second method sequence that operates on a second 3-D object.

A method sequence may comprise one or more methods that operate on a 3-D object as well as perform other functions related to the presentation. For method sequence 610, three methods 600, 604 and 606 are listed. In the method sequence, the methods are used to move the 3-D object described in the model file 534. Input data may be required for each method. For instance, methods 600, 604 and 606 may specify a position of the cylindrical input button in the 3-D gaming environment 650. The input data 602, 606, 608, for each method, may include numerical inputs (e.g., x, y and z coordinates) of the position of the 3-D object in the gaming environment. By changing the numerical inputs, 602, 606 and 608 to the methods 600, 604 and 606, the position of 3-D object may be changed in the animation sequence 616 while allowing the methods 600, 604, 606 to be re-used.

For method sequence 612, three methods 601, 605 and 607 are also listed. In the example, the methods are used to move and scale the 3-D object described in the model file 534. Input data may be required for each method. For instance, methods 601, 605 and 607 may specify a position and a size of the cylindrical input button in the 3-D gaming environment 650. The input data 603, 607, 609, for each method, may include numerical inputs (e.g., x, y and z coordinates) of the position of the 3-D object in the gaming environment and a scaling factor such as 100%, 50% or 200%. By changing the numerical inputs, 603, 607 and 609 to the methods 601, 605 and 607, the position and the size of 3-D object may be changed in the animation sequence 616 while allowing the methods 601, 605, 609 to be re-used. For instance, by changing the input data, 603, 607 and 609, to methods 601, 605 and 607, the cylindrical 3-D object may be made to grow in size rather than shrink in size.

The methods in the script file 536 may produce a series of objects that are used as part of the animation sequence 616. For instance, methods 600, 604, 606, 601, 605 and 607 may be used to generate 3-D objects 620, 621, 622, 623, 624 and 625. The position and size of the objects 620, 621, 622, 623, 624 and 625 in 3-D gaming environment 650 are shown in the figure. Each object generated by the methods in the script file 536 in the animation sequence 616 may be rendered 652 to a separate video frame 655. The video frames may be displayed to a display screen on the gaming machine.

When played in sequence, the sequence of video frames may generate an appearance of an animation to a player viewing the display screen of the gaming machine. For instance, when objects, 620, 621, 622, 623, 624 and 625 are each rendered 652 to a separate video frame and the sequence of video frames are displayed on the display screen, the cylindrical function may appear to move and shrink on the display screen as a function of time. Thus, the sequence of frames generated by the presentation module using the method sequences 610 and 612 may be used provide the animation sequence 616. The animation sequence 616 may be used as a presentation component in a game outcome presentation on a gaming machine.

The methods and the input data in a script file 536 may be re-used with a different model file 534. In general, the methods and input data are independent of the 3-D object described in the model file 534. Thus, by changing the 3-D object(s) in the model file 534 a different animation sequence may be generated. For instance, instead of the input button being cylindrical in the animation sequence 616, the input button may be made rectangular by changing the model in the model file 534 while reusing the methods 600, 604, 606, 601, 605 and 607 with their respective input data. The re-use of methods, input data and the exchangeability of model files may simplify and speed-up the design process of game outcome presentation.

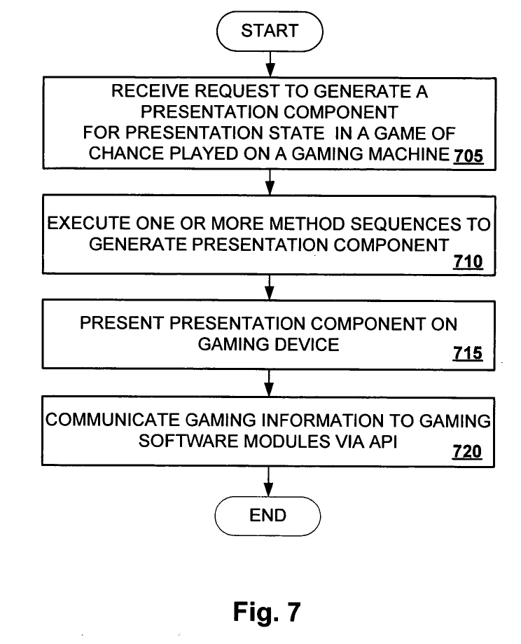

FIG. 7 is a flow chart of a method for presenting a presentation component on a gaming machine. In 705, a presentation module receives a request to generate a presentation component for a presentation state in a game of chance played on a gaming machine. The presentation component may be a graphical component such as an animation displayed on a display screen on the gaming machine, an audio component such as music output on an audio device on the gamin machine or a gaming device component, such as light pattern displayed on a light panel located on the gaming machine. In 710, the presentation module executes on or more method sequences to generate the presentation component. The method sequences may be stored in a script file on the gaming machine. In 715, the presentation component is presented on a gaming device such as a display screen, audio device, light panel, bonus wheel or a mechanical reel. In 720, the presentation module may communicate gaming information to one or more gaming software modules via an API. For instance, the presentation module may notify the gaming operating system that the presentation component, such as an animation, is completed.

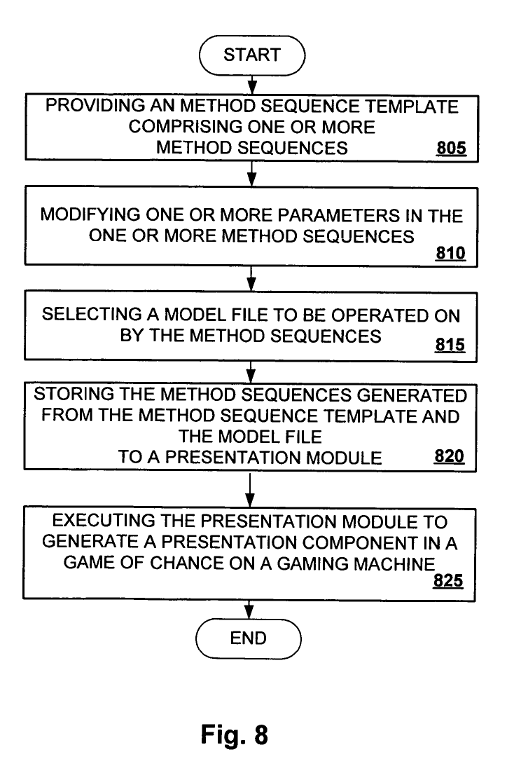

FIG. 8 is a flow chart of a method for generating a presentation component on a gaming machine. In 805, a method sequence template comprising one or more method sequences is generated. The method sequence template may be provided on a presentation module design interface. The method sequence template may describe one or more method sequences that may be used to generate a presentation component on a gaming machine. The presentation component may be a graphical component such as an animation displayed on a display screen on the gaming machine, an audio component such as music output on an audio device on the gaming machine or a gaming device component, such as light pattern displayed on a light panel located on the gaming machine.

In 810, one or more parameters in the one or more method sequences may be modified or specified. In general, a method sequence may comprise one or more methods. Each method may include input parameters that may be used to modify the operation of the method. For instance, a method may be used to generate the color or texture of an object used in an animation sequence. The method may include parameters that may specify the color or texture of the object to be generated. As another example, a method sequence may be used to move an object in an animation sequence. The method sequence may include parameters that may be used to specify the initial and final position of the object and the rate of movement.

In 815, a model file to be operated on by the method sequences is selected. The method sequences may operate on an object. The object may be a graphical component, an audio component or a hardware component. The hardware component may be an abstraction of a gaming device such as a device driver stored in a file. The model file specifies the object to be operated on by the method sequence. In general, the method sequences are independent of the objects in the model files. Thus, the method sequences may be re-used with different objects. For instance, a method sequence that generates an animation of an object moving may be applied to different 3-D objects that are stored in different model files.

In 820, the method sequences generate from the method sequence template and the selected model file may be stored to a presentation module. The presentation module, as described with respect to FIGS. 5A and 5B may be used to generate a presentation component during game play on a gaming machine. In 825, the presentation module is executed to generate the presentation component specified by the presentation module on the gaming machine.

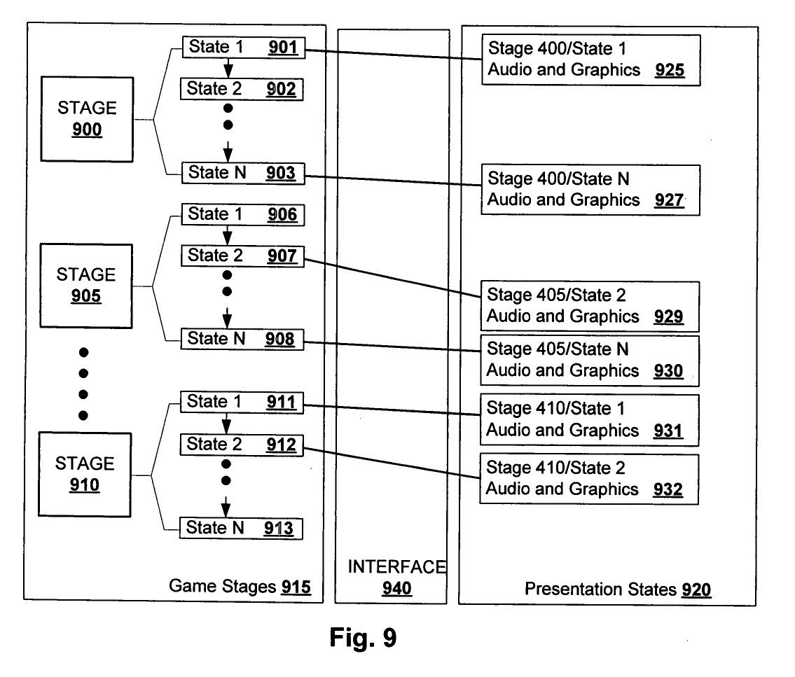

FIG. 9 is a block diagram depicting game stages, states and corresponding presentation states. A game of chance may be divided into a sequence of stages that are controlled by the gaming operating system. The sequence of stages includes at least one stage used to play the game of chance. Other stages in the sequence of stages may be used to present a bonus game, another game of chance or other provide other game play enhancements.

Stages 900, 905 and 910 include game flow logic used to play a game of chance on a gaming machine such as a card game or slot game or game flow logic to play a bonus game. A plurality of game stages 915, such as stage 900, 905 and 910 may be installed on the gaming machine as part of a game package. A plurality of stages may be installed on a gaming machine at a particular time. In addition, in some embodiments, stages may be downloaded from a game server.

As an example of game staging, a first game of chance may played on a gaming machine using a sequence of 3 stages. A first stage, in the sequence of 3 stages, may be stage 900, which is used to play a slot game. A second stage in the sequence of 3 stages is stage 905, which may be used to play a first bonus game and a third stage 910 in the sequence of 3 stages is stage 910 which may be used to play a second bonus game. As another example of game staging, a second game of chance may be played on the gaming machine using a sequence of 4 stages. A first stage in the sequence of 4 stages, may be stage 900, which is used to play a card game. A second stage in the sequence of 4 stages is stage 905, which may be used to play a first bonus game. A third stage 910 in the sequence of 4 stages is stage 910 which may be used to play a slot game and a fourth stage in the sequence of 4 stages is stage 905 which may be used to play a second bonus game. In this example, stage 905 is used twice in the sequence of stages. In general, a stage may be used one or more times in a sequence of stages.

Each stage may comprise logic to generate a plurality of game states. The game states may be used to perform various game functions such as but not limited to controlling displays on a display screen, starting and stopping animations on the display screen and determining a game outcome. Thus, a portion of the game states in a stage may be designed to control a presentation state while other game states may not be designed to control a presentation state. Three game states 901, 902 and 903 out of a plurality of game states are listed for stage 900, three game states, 906, 907 and 908, out of a plurality of game states are listed for stage 905 and three game states, 911, 912 and 913 out of a plurality of game states are listed for stage 910. As examples of states not controlling a presentation state, state 902 may be used to generate an outcome for a game of chance, state 906 may be used to generate an outcome for a bonus game and state 912 may be used to process an award. As example of states that may control a presentation state, states 901, 903, 907, 908, 911 and 912 are game states that may be used to control the corresponding presentation states 925, 927, 929, 930 and 932. For instance, state 901 may be used to control a game outcome presentation generated by the presentation state 925.

A presentation state may comprise graphics, sound and the activation of other gaming devices on the gaming machine such as lights and mechanical devices. The graphics, sounds and gaming device components for a presentation state may be activated sequentially or may be activated simultaneously depending on the configuration of the presentation state logic. However, when the game state logic is decoupled from the presentation state logic, the game state logic will not have knowledge about the presentation content, such as details about what graphics or sounds are generated and in what order, or knowledge about the logic used to generate the presentation state. Thus, many different presentation states can be developed for the same game state allowing the game state logic to be reused. Further, presentation state logic may also be reused to generate presentations for different presentation states in different games. For instance, the presentation logic for presentation state 925 used for game state 901 in stage 900 may also be used for game state 913 in stage 910.

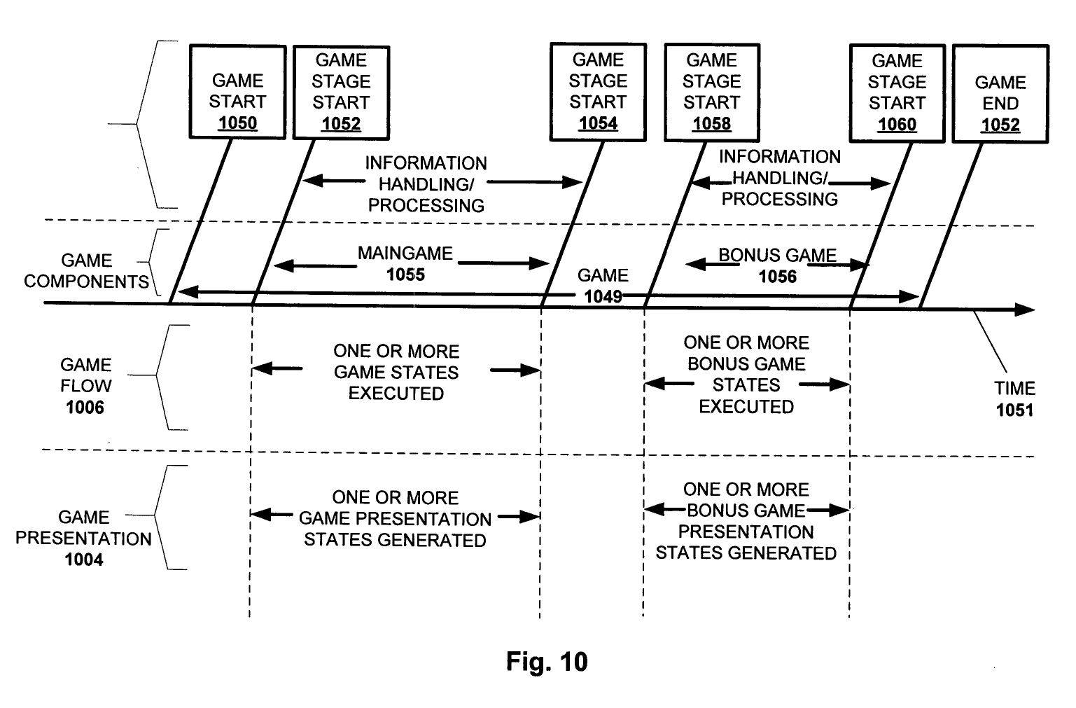

FIG. 10 is a block diagram depicting some interaction of a gaming operating system 502, a game flow logical unit 504 and a game presentation logic unit 506 as a function of time 1051. During the interaction, a main game 1055 and a bonus game 1056 are presented sequentially on the gaming machine. A game of chance may comprise a sequence of stages where at least one stage is game stage. In FIG. 10, the game of chance comprises two stages including a game stage and a bonus game stage. In the present invention, a game may comprise one or more stages.

A GAME_START event is generated at the beginning of each game of chance. As each stage starts, a GAME_STAGE_START event is generated. When each stage completes, a GAME_STAGE_END event is generated. When all game stages are complete the game manager or another process in the gaming operating system 502 may declare the entire game is complete by posting a GAME_END event. With this design, the GAME_END event is final and all system components can detect this event to know a game is complete.

In FIG. 10, the game 1049 starts with GAME_START event 1050 and the game ends with GAME_END event 1051. The game 1049 includes two stages: 1) a main game 1055 and 2) a bonus game 1056. The main game 1055 begins with GAME_STAGE_START event 1052 and ends with GAME_STAGE_END event 1054. The bonus game 1056 begins with GAME_STAGE_START event 1058 and ends with GAME_STAGE_END event 1060.

As described above, during the main game 1070, the game OS 502 may perform information handling and information processing tasks such as processing and routing game events posted from the game flow logic 504 and the game presentation logic 506 as well as game events posted from logical units located in the game OS 502. The game flow logic 504 may execute a series of game states controlling the play of the game 1055 and post game events to inform other logic units in the gaming system of its state. The game presentation logic 506 may generate a series of presentation states to allow the presentation of the game 1055 generated by the game flow 504. The game presentation logic 506 may also post game events to inform other logic events of its state. The game OS 502, game flow 504 and game presentation 506 may perform similar operations during the generation of the bonus game 556.

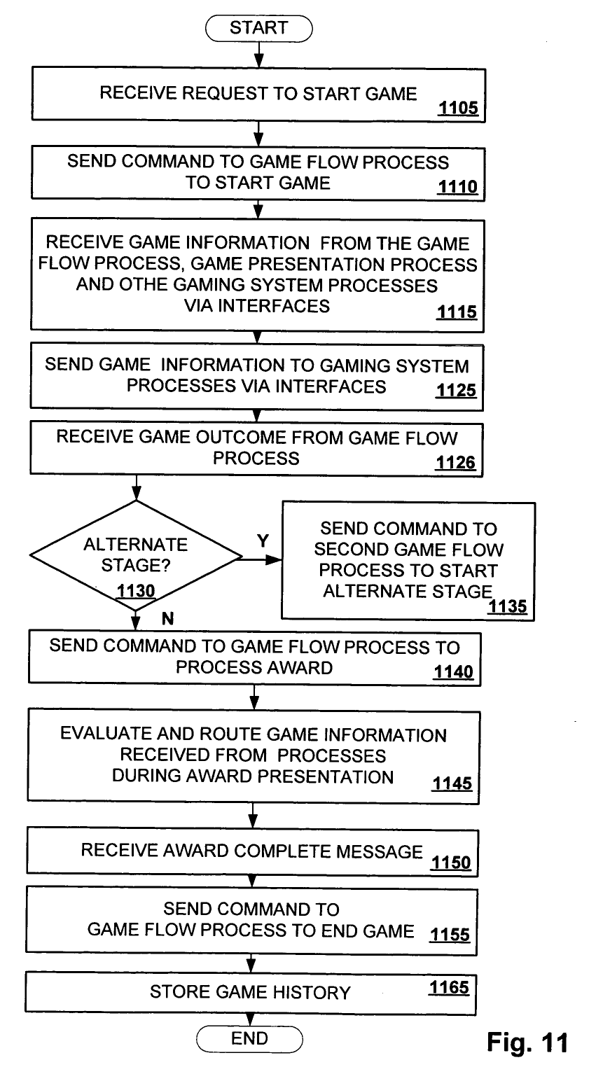

FIG. 11 is a flow chart depicting a method in a gaming operating system of playing a game on a gaming machine. The gaming operating system and other gaming system software modules, such as the game flow software module and the game presentation software module, may be loaded into RAM and executed as processes. The gaming operating system may be loaded when the gaming machine is powered-up. Other gaming system software modules may be loaded and unloaded from RAM while the gaming machine is operating.

In 1105, the gaming operating system receives a request to start a game from one of the input mechanisms located on the gaming machine. The request may be initiated when a player deposits credits into the gaming machine via a gaming device such as bill validator or a coin acceptor. In 1110, the gaming OS sends a command to a game flow process via an interface to start a game. In one embodiment, the command is sent from a game manager process in the operating system. In 1115, during game play the gaming OS receives game information from the game flow process, game presentation process and other gaming system process via one or more interfaces. In 1125, game information is sent to various game system processes. For instance, as described above, the game OS may route sequence events to the game flow process and may route sequence events to the game presentation process to generate the game play on the gaming machine. In 1126, the game OS may receive a game outcome determined by the game flow process.

In 1130, the game OS may evaluate the game outcome to determine if staging event has occurred. In 1135, when a staging event has occurred, the game flow may send a command to a second game flow process such as a bonus game flow process to start the alternate stage. In a single game, the game OS may start and end a plurality of stages. In 1140, when a staging event has not occurred, the game OS sends a command to the game flow process to process the award indicated by the game outcome. The award process may involve a presentation on the display screen of the gaming machine showing the award to the game player.

In 1145, during the award presentation, the game OS may evaluate and route game information received from various game processes, such as the game flow process and game presentation process, during the award presentation via one or more interfaces. In 1150, the gaming OS receives an award complete message from the game flow process. In 1155, the game OS sends a command to the game flow process to end the game. In 1165, the game OS may store the game history for the game to a non-volatile memory storage device.

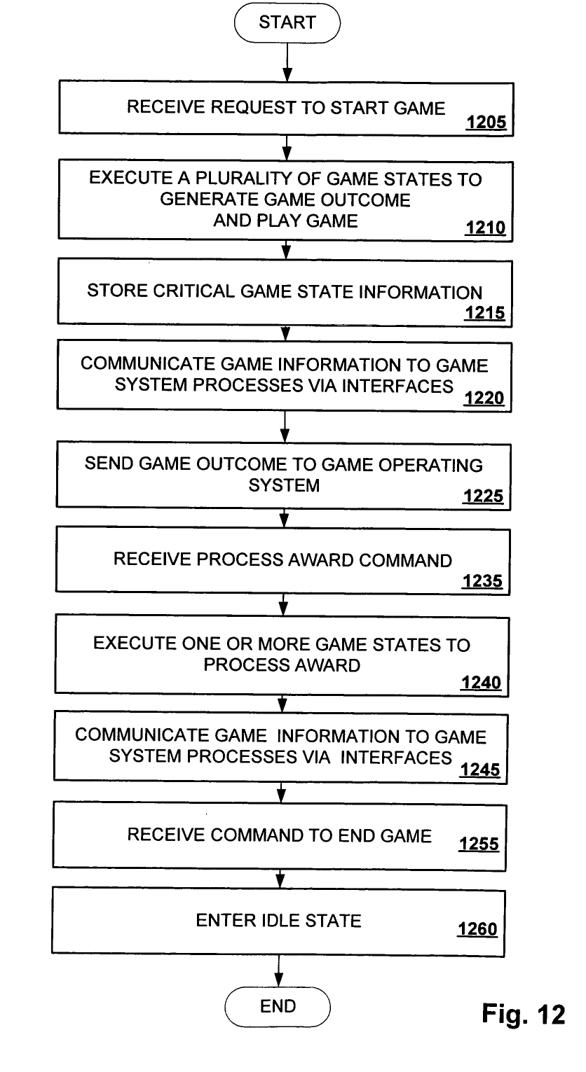

FIG. 12 is a flow chart depicting a method in a game flow software module of playing a game on a gaming machine. In 1205, the game flow software module, which may be loaded into RAM on a gaming machine, receives a request to start a game. When the game flow software module and other game software modules are loaded into RAM, the gaming operating system may treat the modules as processes executing on the gaming machine. In 1210, the game flow software module executes a plurality of game states to generate the play of a game of chance on the gaming machine including determining the game outcome and controlling the presentation of the game. In 1215, the game flow software module may store critical game state information such as the game outcome to a non-volatile storage device on the gaming machine. In 1220, the game flow software module may communicate game information to other gaming system processes via one or more interfaces. In 1225, the game flow software module sends the game outcome it has determined to the gaming operating system. In one embodiment, the game outcome may be processed by a game manager software module included in the gaming operating system.

In 1235, the game flow software module receives a command to process an award for the game outcome. In 1240, the game flow software module executes one or more game states to process the award which may involve a presentation on one or more displays on the gaming machine. In 1245, the game flow software module may communicate game information to other gaming system processes via one or more interfaces. For instance, the game flow process may communicate gaming information to the presentation software to control the presentation. As another example, the game flow process may communicate gaming information to the gaming operating system indicating the award presentation has been completed. In 1255, after completing the award presentation, the game flow process may receive a command from the operating system to end the game. In 1260, the game flow process may enter an idle state.

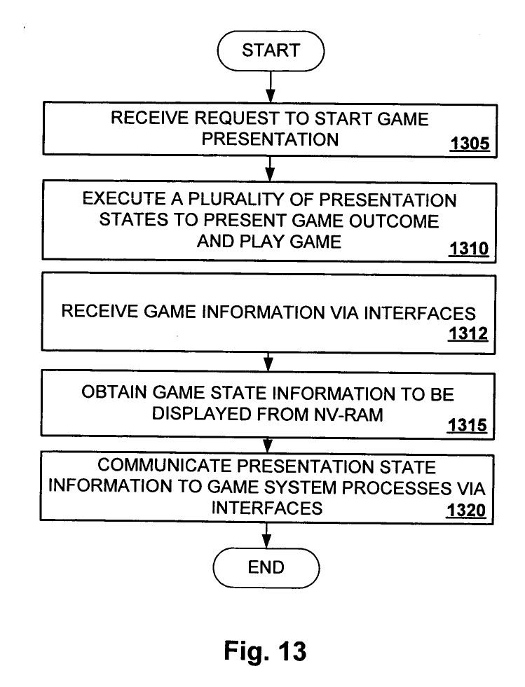

FIG. 13 is a flow chart depicting a method in a game presentation software object of playing a game on a gaming machine. In 1305, the game presentation software module which may be loaded into RAM on a gaming machine as a process, receives a command to start a game presentation. In 1310, the game presentation process executes a plurality of presentation game states corresponding to one or more games states generated by the game flow processes. To generate a presentation state, the game presentation process may execute logic enabling graphics to be displayed on one or more display screens on the gaming machine and sounds to be output from audio devices on the gaming machine. Details of the graphical presentation that may be presented as part of the game play on the gaming machine are described in co-pending U.S. application Ser. No. 09/927,901, filed on Aug. 9, 2001, by LeMay, et al., titled “Virtual Cameras and 3-D Gaming Environments in a Gaming Machine,” which is hereby incorporated by reference.

Besides enabling graphics and sounds, the game presentation process may execute logic to enable other gaming devices such as lights, lighted displays and bonus wheels to be activated on the gaming machine as part of the presentation. The game presentation process may also be used enable the display of various meters, game status information and input buttons on one or more display screens on the gaming machine. The input buttons may be used for betting, starting the game and playing the game. The game presentation process may also receive information regarding touch screen events for input buttons it has generated on the display screen.

In 1312, the game presentation process may receive gaming information via gaming events, such as sequence events, from other game processes via one or more interfaces. In 1315, the game presentation process may obtain game state information to be displayed to the display screen from non-volatile memory on the gaming machine. In 1315, the game presentation process may communicate presentation state information to game system process one or more interfaces. For instance, in one embodiment, the game presentation process may post a sequence event to the game OS.

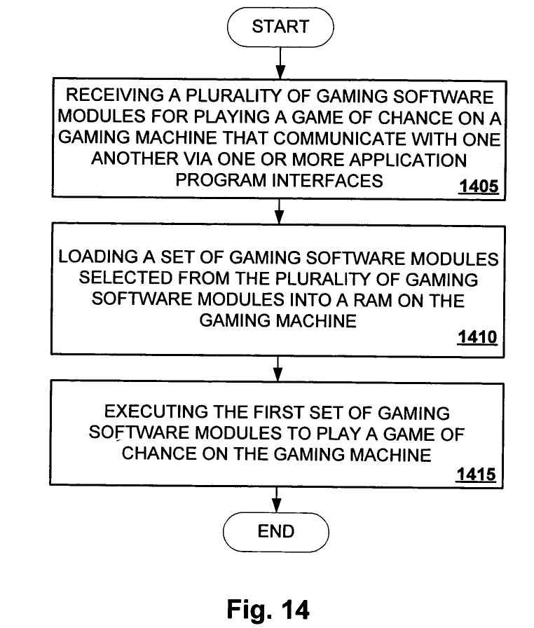

FIG. 14 is a flow chart depicting a playing a game on a gaming machine using a plurality of gaming software modules. In 1405, the gaming machine receives a plurality of gaming machine software modules for playing a game chance. The operating system software modules are generally installed onto the gaming machine prior to shipping. Additional gaming software modules may be loaded onto the gaming machine as part of a game package. In 1410, a set of gaming software modules selected from the plurality of gaming software modules is loaded into RAM on the gaming machine. In general, the set of game software modules loaded into RAM comprise at least a gaming OS, a game flow software module that generates the game flow sequence for the game of chance and a game presentation software module that presents the game of chance on a display screen on the gaming machine. The software modules loaded into RAM may be executed as processes on the gaming machine. Various gaming software modules may be loaded and unloaded from RAM by the gaming OS as the gaming machine is running. In 1415, a first set of gaming software modules are executed to play a game of chance.

In one embodiment of the present invention, the gaming OS may load a different sets of software modules selected from the plurality of gaming software modules to play different types of games of chance such as a slot game or a card game. The plurality of gaming software modules may reside on a memory device on the gaming, on a remote device such as a gaming server or combinations thereof.

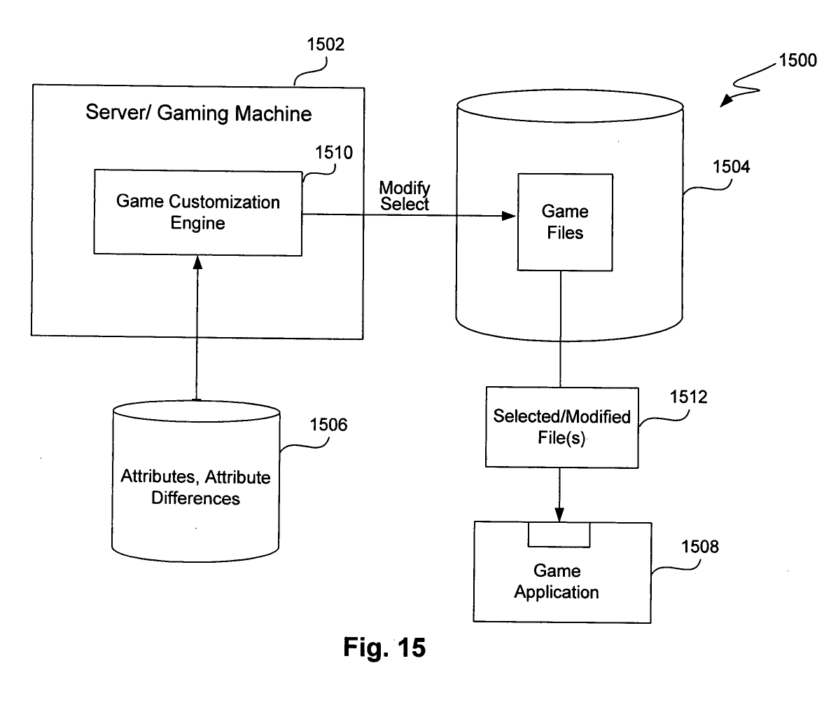

FIG. 15 shows a system 1500 for customizing a game application to be executed on a gaming machine, constructed in accordance with one embodiment of the present invention. Gaming system 1500 includes a server or gaming machine 1502 or other suitable data processing device as described above. The system 1500 further includes a game file storage medium 1504 for storing game files to be used by the executing game application. Examples of such game files include audio and video presentation data files, game software modules, and other data files to be used by the executed game application. A further storage medium 1506 stores attributes and attribute differences for one or more players. A game application 1508 is also illustrated in FIG. 15. Those skilled in the art will appreciate that game application 1508 is executed on a suitable gaming machine as described herein.

In FIG. 15, in one implementation, system 1500 is implemented as a server based gaming system. In this implementation, the server 1502 includes a game customization engine 1510, which is implemented in software, hardware, or a combination thereof, to carry out the operations of customizing game application 1508, as described herein. In this server based gaming configuration, server 1502 can be situated at a remote location with respect to the gaming machine on which game application 1508 is executed, and server 1502 communicates with that gaming machine over a suitable communications network. Attribute storage medium 1506 can be coupled directly to or within server 1502 as a suitable memory device, or situated in a separate database, also in communication with server 1502 over an appropriate communications network. In this implementation, game file storage medium 1504 can be implemented as a memory device coupled directly to server 1502, the gaming machine, or accessible by the server and the gaming machine over the appropriate communications network.

In an alternative implementation, in FIG. 15, the game customization engine 1510 is implemented in the master gaming controller of a gaming machine 1502. Thus, in this alternative implementation, the game file storage medium 1504 and attribute storage medium 1506 can be coupled directly to the gaming machine or again situated remotely with respect to the gaming machine.

In FIG. 15, as will be described in greater detail below, one or more files 1512 are selected and/or modified by game customization engine 1510 responsive to some event. The selected/modified files 1512 are retrieved from game file storage medium 1504 and delivered to the executing game application 1508. The game customization engine 1510 controls the selection, modification, and any updating of the game files stored in game file storage medium 1504. The game customization engine 1510 performs this selection and modification based on attribute differences stored in attribute storage medium 1506.

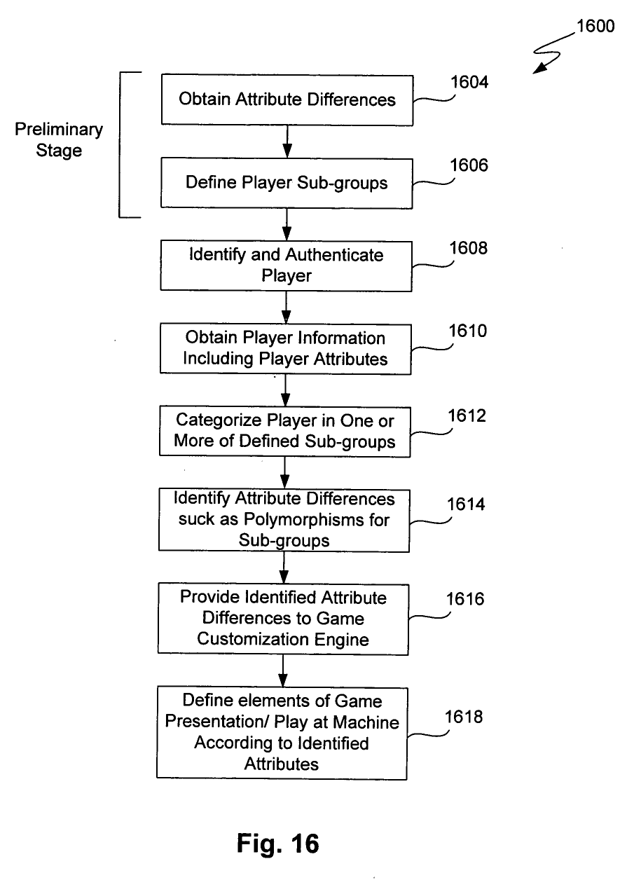

FIG. 16 shows a method 1600 for customizing a game application using attribute differences to implement a scenario-based gaming configuration according to one embodiment of the present invention. The method 1600 of FIG. 16 is described with reference to a server based gaming configuration of the system 1500 of FIG. 15. Those skilled in the art will understand that method 1600 can be performed in the alternative gaming machine implementation of system 1500 of FIG. 15 as described above.

In FIG. 16, the method 1600 includes two preliminary steps 1604 and 1606 for setting up groups and sub-groups of players according to attribute differences, as described above. In particular, in step 1604, attribute differences are obtained from sets of attribute values, as described above with respect to FIGS. 4A and 4B. In step 1606, player subgroups are defined according to these attribute differences. A list of the subgroups according to attribute differences can be stored and maintained in attribute storage medium 1506.

Those skilled in the art will appreciate that the preliminary steps 1604 and 1606 of method 1600 are preferably performed once, while the remaining steps of method 1600 described below, can be repeatedly performed as necessary to customize game application 108 for various players of the gaming machine.

In step 1608, a player of game application 1508 is identified and authenticated. For instance, responsive to the player inserting a player tracking card in the gaming machine, the gaming machine can read player identification information and gather or retrieve other information to verify the player's identity. In step 1610, the player identification information read from the tracking card is used to access a player data storage medium, such as attribute storage medium 1506, to retrieve attributes stored for that particular player. Then, in step 1612, the player can be categorized in one or more of the subgroups defined in step 1606, as illustrated in FIG. 4B. Once the player is categorized into one of the subgroups, the method 1600 proceeds to step 1614 with identifying attribute differences such as single relational polymorphisms, as described above, for the particular sub-group or sub-groups in which the player is classified.

Those skilled in the art should appreciate that steps 1610-1614 represent one implementation for obtaining attribute differences associated with a player. Other implementations are contemplated within the scope of the present invention. For instance, the database can be maintained in which the attribute differences themselves are stored for each player. In another implementation, the groups and subgroups into which the player can be categorized are directly identified as associated with the player and a suitable memory device such as attribute storage medium 1506. Thus, using any of these various implementations, the attribute differences for the player of game application 108 can be identified and retrieved for processing.

In FIG. 16, in step 1616, the identified attribute differences are retrieved from storage medium 1506 and provided to game customization engine 1510. Regardless of whether game customization engine 1510 is located in a remote server 1502, the gaming machine, or other network location, in step 1618, the game customization engine can use the identified attribute differences to customize the game presentation and/or game play of game application 1508 at the player's gaming machine according to the identified attribute differences.

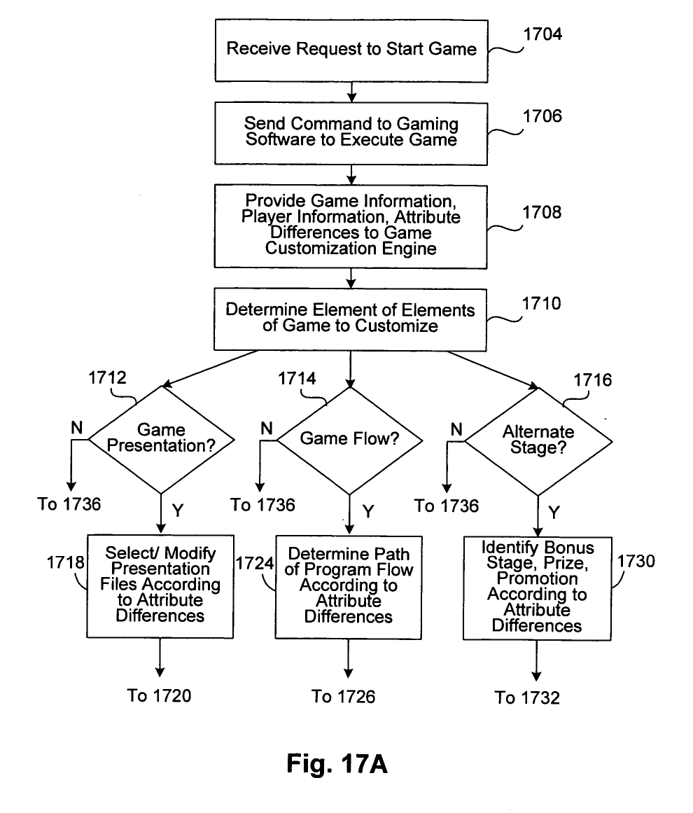

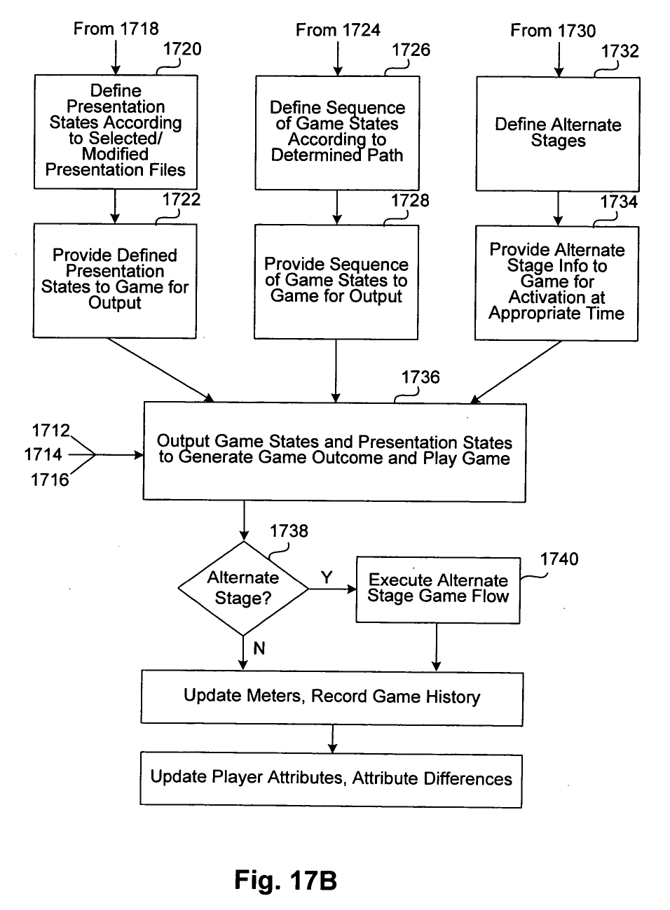

FIGS. 17A and 17B show a method 1618 of customizing the game application 1508 at the player's gaming machine using identified attribute differences, performed in accordance with one embodiment of the present invention. Method 1618 begins in step 1704 in which the gaming machine receives a request signal to play game application 1508. In step 1706, responsive to the request signal received in step 1704, the master gaming controller loads the appropriate game application software and data to execute game application 1508. In step 1708, responsive to execution of game application 1508, preferably concurrent with the output of one or more initial game states, game information identifying the particular game application, any player information, such as player identification information needed to identify the player of the game application 1508, and the identified attribute differences from step 1614 are provided to game customization engine 1510 in FIG. 15.

In FIG. 17A, in step 1710, responsive to receiving the attribute differences and other information of step 1708, game customization engine 1510 determines which element or elements of game application 1508 to customize. According to embodiments of the present invention, various aspects of game application 1508 can be customized. These elements or aspects of game application 1508 include the game presentation 506, game flow 504, and one or more alternate stages of the game application 1508, which may have further game presentation and game flow elements as will be appreciated by those skilled in the art.

In FIG. 17A, following step 1710, game customization engine 1510 customizes game application 1508 as dictated by the identified attribute differences for that player. In step 1712, when game customization engine 1510 determines that the presentation of game application 1508 is to be customized, presentation files associated with game application 1508 and stored in game file storage medium 1504 are selected and/or modified according to the identified attribute differences, in step 1718. The selected/modified files 1512 are retrieved from game file storage medium 1504 and delivered to the gaming machine on which game application 1508 is executing. In FIG. 17B, in step 1720, one or more presentation states of game application 1508 are defined using the selected/modified files 1512. In step 1722, the defined presentation states are provided to the gaming machine for output as part of game application 1508.

In FIG. 17A, returning to step 1710, when it is determined that the game flow is to be customized, in step 1714, the game customization engine 1510 is configured to determine the path of program flow for game application 1508 according to the identified attribute differences, in step 1724. In FIG. 17B, the sequence of game states are defined by game customization engine 1510, in step 1726, according to the determined path of program flow. The defined sequence of game states is then provided to the master gaming controller of the gaming machine on which game application 1508 is to be played, in step 1728.

In FIG. 17A, following step 1710, when it is determined that the alternate stage of game application 1508 is to be customized, in step 1716, the method proceeds to step 1730 in which game customization engine 1510 identifies the appropriate bonus stages, prizes, promotions, or other alternate stages of game application 1508 to customize according to the identified attribute differences. Following identification of these stages, the method proceeds to step 1732 of FIG. 17B to define modifications to those alternate stages according to the attribute differences. In some instances, this definition of alternate stages includes defining additional presentation states and/or additional game states, which comprise the alternate stage of game play. In some embodiments, further elements are defined, such as an amount of bonus award, a type of bonus stage, a prize amount or type, and selection of a casino promotion. Following step 1732, the method proceeds to step 1734 of FIG. 17B in which the alternate stage information defined in step 1732 is provided to the gaming machine for activation of the alternate stage at an appropriate time.

In FIG. 17B, following steps 1722, 1728 and 1734, when the various presentation states, game states, and any alternate stages of the game are defined, the method proceeds to step 1736 to output the game states, presentation states and alternate stages of the newly customized game application 1508 to generate the game outcomes and play the game. Any alternate stages are triggered at the appropriate times, in steps 1738 and 1740. When game play is concluded, in step 1742, the meters are updated and the game history is recorded, in accordance with IGT gaming practices. Following completion of game play, in step 1744, the player's attributes and, in some implementation, attribute differences can be updated using the information gathered from the completed game play session.

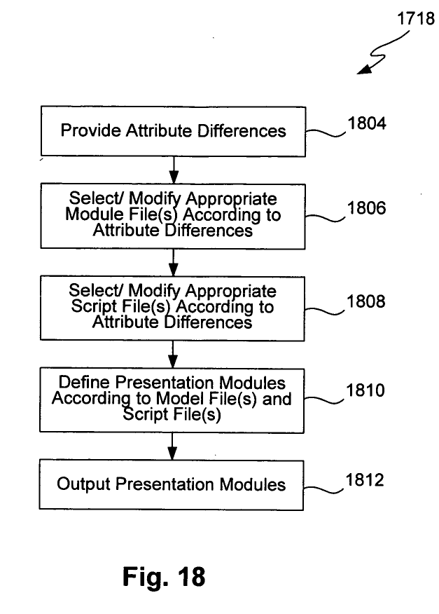

FIG. 18 shows a method 1718 of customizing the game presentation, performed in accordance with one embodiment of the present invention. In step 1804, the attribute differences identified for the player are provided to game customization engine 1510. Responsive to receiving these attribute differences, in step 1806, game customization engine 1510 selects and/or modifies the appropriate module files stored in game file storage medium 1504 according to the attribute differences. Similarly, in step 1808, game customization engine 1510 selects and/or modifies the appropriate script files in game file storage medium 1504 according to the attribute differences. In step 1810, selected and modified module files and script files are used by game customization engine 1510 to define one or more presentation modules. In step 1812, the defined presentation modules can be used by the presentation logic of the gaming software to define one or more presentation states of the game application 1508. These presentation states are customized for the player using the techniques described above.

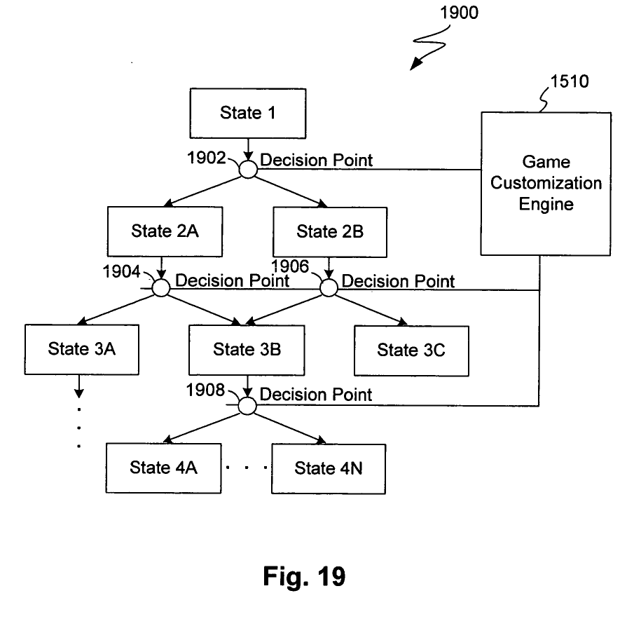

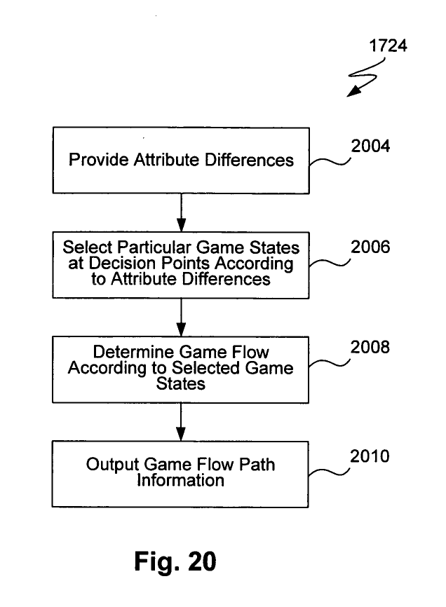

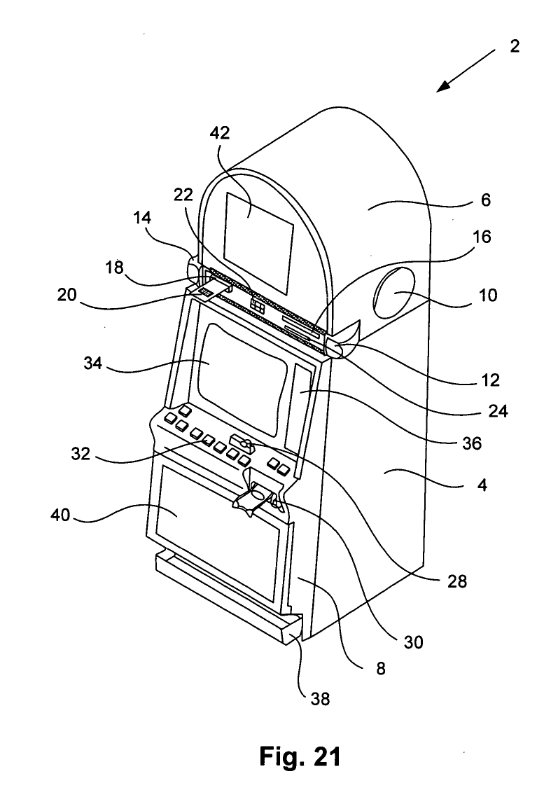

FIG. 19 shows a state diagram 1900 illustrating a sequence of states for the execution of the game application. In FIG. 19, the state diagram 1900 can be applied to both a sequence of presentation states, and/or a sequence of game states. Those skilled in the art will appreciate that the state diagram 1900 represents a simplified illustration of one possible implementation of a game application, performed in accordance with embodiments of the present invention. The state diagram 1900 is not intended to limit the scope of the present invention to a state sequence shown in that diagram.

In FIG. 19, the state diagram shows a sequence of states or sets of states, which can be selected to define a program flow. For instance, in a flow of game states, state 1 represents the first state of executing game application 1508. Following the output of state 1, game flow can proceed to either state 2A or state 2B. As shown, game customization engine 1510 processes attribute differences at decision point 1902 to determine the flow of game application 1508 from state 1 to either state 2A or state 2B. Similarly, game customization engine 1510 provides input at decision points 1904 and 1906 to determine which state the game application should output following state 2A or state 2B. The processing continues so that the particular sequence of states can be selected and customized for each player depending on the attribute differences associated with that player.

In FIG. 20, a method 1724 of game flow customization is shown, according to one embodiment of the present invention. At step 2004, attribute differences for the player are provided to game customization engine 1510. Responsive to receiving the attribute differences, game customization engine 1510 selects particular states for the game flow at each of the decision points 1902-1908, as shown in FIG. 19, according to the attribute differences, in step 2006. By selecting the particular states for game flow, in step 2008, a game flow path is determined according to the selected game states. Information defining or describing this game flow path is then provided, in steps 2010, to the gaming software so that the sequence of states can be output by the game flow logic.

In FIGS. 19 and 20, the state diagram 1900 and method 1724 provide one embodiment of a technique for modifying game flow of game application 1508 based on attribute differences determined for the player. Thus, during execution of the game application, at the decision points 1902-1908, the game application can branch to particular states defined for that player, although any of several branches can occur, depending on the attribute differences for that player. Any number of game stages can be defined for a single game, using these branches. In one embodiment, a number of dynamic game code libraries are provided. Game flow can be recurring, as will be appreciated by those skilled in the art of game application design. In one implementation, when a certain piece of game code is reached, a certain block of game code is called based on the attribute differences. Thus, the various decision points in FIG. 19 are based on the subgroup into which the player is classified according to his or her attribute differences. In one embodiment, the various decision points are built into the game code itself, so the decisions are performed dynamically during execution of the game application. This allows for a robust handling of game play for various players with various needs.

Groups and subgroups of players can be defined by a game application developer according to attribute differences, as desired. The game application developer can decide where to build decision points into the game code to affect how game flow logic can possibly change as game flow branches from state to state.

In FIG. 21, a video gaming machine 2 constructed according to one embodiment of the present invention is shown. Machine 2 includes a main cabinet 4 which generally surrounds the machine interior (not shown) and is viewable by users. The main cabinet includes a main door 8 on the front of the machine that opens to provide access to the interior of the machine. Attached to the main door are player-input switches or buttons 32, a coin acceptor 28, a bill validator 30, a coin tray 38, and a belly glass 40. Viewable through the main door is a video display monitor 34 and an information panel 36. The display monitor 34 is typically a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. a master gaming controller) housed inside the main cabinet 4 of the machine 2.

In FIG. 21, the information panel 36 may be used as an interface to provide player tracking services and other game services to a player playing a game on the gaming machine 2. The information panel 36 may be used as an interface by a player to: 1) input player tracking identification information, 2) view account information and perform account transactions for accounts such as player tracking accounts and bank accounts, 3) receive operating instructions, 4) redeem prizes or comps including using player tracking points to redeem the prize or comp, 5) make entertainment service reservations, 6) transfer credits to cashless instruments and other player accounts, 7) participate in casino promotions, 8) select entertainment choices for output via video and audio output mechanisms, 9) play games and bonus games, 10) request gaming services such as drink orders, 11) communicate with other players or casino service personnel and 12) register a player for a loyalty program such as a player tracking program. In addition, the information panel 36 may be used as an interface by casino service personnel to: a) access diagnostic menus, b) display player tracking unit status information and gaming machine status information, c) access gaming machine metering information and d) display player status information.

Many different types of games, including mechanical slot games, video slot games, video poker, video black jack, video pachinko and lottery, may be provided on gaming machine 2. The gaming machine 2 is operable to provide play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may execute game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

In FIG. 21, the gaming machine 2 includes a top box 6 which sits on top of the main cabinet 4. The top box 6 houses a number of devices which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. The top box 6 may house various devices. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming devices on which the present invention may be implemented. For example, not all suitable gaming machines have top boxes or player tracking features. Further, some gaming machines have only a single game display—mechanical or video—while others are designed for bar tables and have displays that face upwards. As another example, a game may be generated on a host computer and may be displayed on a remote terminal or a remote gaming device. The remote gaming device may be connected to the host computer via a network of some type such as a local area network, a wide area network, an intranet or the Internet, by a wired or wireless connection. The remote gaming device may be a portable gaming device such as but not limited to a cell phone, a personal digital assistant, and a wireless game player. Images rendered from 3-D gaming environments may be displayed on portable gaming devices that are used to play a game of chance. Further, a gaming machine or server may include gaming logic for commanding a remote gaming device to render an image from a virtual camera in a 3-D gaming environment stored on the remote gaming device and to display the rendered image on a display located on the remote gaming device. Thus, those of skill in the art will understand that the present invention, as described below, can be deployed on most any gaming machine now available or hereafter developed.

Some preferred IGT gaming machines are implemented with special features and/or additional circuitry that differentiates them from general-purpose computers (e.g., desktop personal computers and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements, and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computer systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. This requirement affects the software and hardware design on a gaming machine. As anyone who has used a PC knows, PCs are not state machines and a majority of data is usually lost when such a malfunction occurs.

In one embodiment of the present invention, the gaming machine software defines a state. A state is critical data that contains a state value, critical data modifiers and substates. The state value is an integer value that has meaning to the user of the state. The critical data modifiers are types of critical data that store information about how to modify critical data. Substates are states themselves, but are linked to the state.

The critical data modifiers may be stored and associated with the state using a list. Typically, the critical data modifiers may be grouped to form a list of critical data transactions. A critical data transaction is usually comprised of one or more critical data modifiers. For instance, a critical data transaction to print an award ticket might comprise the operations of 1) start using printer, 2) disable hopper and 3) decrement the credits on the gaming machine by the amount printed to the award ticket where each operation is comprised of one or more critical data modifiers. The list is maintained as critical data to ensure that the items on the list are always valid i.e. the list may not be lost in the event of a power failure or some other gaming machine malfunction. All the transactions in a list for a state are completed or all the transactions are not completed which is a standard transaction technique.

The critical data transactions are a description of how to change critical data. The transactions can be executed by an NV-RAM manager after requests by clients. The list is built until the gaming machine software executes the list by changing the state value which is the mechanism for initiating a transaction. If power is lost to the gaming machine during a transaction, the transaction can be completed due to the design of the state. On power recovery, the gaming machine can determine what state it was in prior to the power failure and then execute the critical data transactions listed in the state until the transactions are completed. For a given state, once the critical data transactions listed in the state are complete, the information describing the critical data transactions comprising the state may be discarded from the non-volatile memory and the gaming machine software may begin execution of the next state.

One feature of the state based transaction system using the non-volatile memory is that the gaming system software may determine when a rollback is required. Once a list of critical data transactions is built as part of the state, the transactions may be executed or rolled back. A rollback occurs when the entire list of critical data transactions is discarded and operations specified in the transactions are not executed. The state-based transaction based system is designed such that it is not possible for only a portion of the list of transactions in a state to be performed i.e. the entire list of transactions in the state may either be rolled back or executed. This feature of the state-based system tends to improve the software reliability and capability because errors due to the partial execution of states do not have to be considered in the software design. It also allows for faster software development.

A second important difference between gaming machines and common PC based computer systems is that for regulation purposes, the software on the gaming machine used to generate the game of chance and operate the gaming machine has been designed to be static and monolithic to prevent cheating by the operator of the gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulator in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burned, approved by the gaming jurisdiction and installed on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and in some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is that the number and kinds of peripheral devices used on a gaming machine are not as great as on PC based computer systems. Traditionally, in the gaming industry, gaming machines have been relatively simple in the sense that the number of peripheral devices and the number of functions of the gaming machine have been limited. Further, in operation, the functionality of gaming machines were relatively constant once the gaming machine was deployed, i.e., new peripheral devices and new gaming software were infrequently added to the gaming machine. This differs from a PC where users will buy different combinations of devices and software from different manufacturers and connect them to a PC to suit their needs depending on a desired application. Therefore, the types of devices connected to a PC may vary greatly from user to user depending on their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators, ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in IGT gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of some preferred circuits is that the operating software cannot completely disable the function of the watchdog timer. In other words, the watchdog timer always functions from the time power is applied to the board.

IGT gaming computer platforms preferably use several power supply voltages to operate portions of the gaming machine circuitry. These can be generated in a central power supply or locally on the circuit board. If any of these voltages falls out of the tolerance limits of the circuitry they power, unpredictable operation of the gaming machine may result. Though most modern general-purpose computers include voltage monitoring circuitry, these types of circuits only report voltage status to the operating software. Out of tolerance voltages can cause software malfunction, creating a potential uncontrolled condition in the gaming computer. IGT gaming machines typically have power supplies with tighter voltage margins than that required by the operating circuitry. In addition, the voltage monitoring circuitry implemented in IGT gaming machines typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This ensures the player's wager and credits are preserved and minimizes potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at just prior to the malfunction including an indication of selections that have already been made by the player. In general, the gaming machine may be restored to any state in a plurality of states that occur in the game of chance while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion. Further details of a state based gaming system, recovery from malfunctions and game history are described in U.S. Pat. No. 6,804,763, titled “High Performance Battery Backed RAM Interface”, U.S. Pat. No. 6,863,608, titled “Frame Capture of Actual Game Play,” U.S. application Ser. No. 10/243,104, titled, “Dynamic NV-RAM,” and U.S. application Ser. No. 10/758,828, titled, “Frame Capture of Actual Game Play,” all of which are hereby incorporated by reference.

Another feature of gaming machines, such as IGT gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents in a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. Some details related to trusted memory devices that may be used in the present invention are described in U.S. Pat. No. 6,685,567 from U.S. patent application Ser. No. 09/925,098, filed Aug. 8, 2001 and titled “Process Verification,” which is hereby incorporated by reference.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 21, when a user wishes to play the gaming machine 2, he or she inserts cash through the coin acceptor 28 or bill validator 30. Additionally, the bill validator may accept a printed ticket voucher which may be accepted by the bill validator 30 as indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the information panel 36 and video display screen 42 located in the top box.

During the course of a game, a player may be required to make a number of decisions which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one or more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

An important aspect of the present invention is game software licensing and game license management. When a gaming platform is capable of providing multiple games to a game player based upon a game selection made by the player or an operator, it may be desirable from both an operator perspective and a content provider perspective to provide capabilities for allowing more complex game licensing methods. The operator and content provider may use the licensing capabilities to enter into licensing agreements that better reflect the value of the content (e.g., game software) to each party. For instance, the licensing parties may agree to utility model based licensing schemes, such as a pay-per-use scheme. In a pay-per-use scheme, operators only pay for game software that is utilized by their patrons, protecting them from software titles that are “duds.”

Game platforms exist that provide access to multiple electronic games. On these devices, a game selection menu may be provided on a video display, which offers the patron the choice of at least two electronic games. A game player may select a game of their choice from the games available on the gaming machine. Typically, the choices of games available to the player are only those licensed for play on the gaming platform. The gaming platform may provide a manual mechanism, such as a display interface on the gaming machine, for updating and renewing licensing on the gaming machine.

In some game platforms offering multiple games, the games are stored on read-only memory devices, such as an EPROM chip set or a CD-ROM. To provide a new or a different game on a gaming platform of this type, a technician, usually accompanied by a gaming regulator, must manually install a new memory device (e.g. EPROM) and then manually update the licensing configuration on the gaming machine. The gaming regulator then places evidence tape across the EPROM. The evidence tape is used to detect tampering between visits by the gaming regulator. Since operations performed by entities other than a “trusted” 3^{rd} party, such as a gaming regulator, have been deemed untrustworthy, automatic game downloads and automatic licensing management is not available on these platforms.

The licensing of multiple games on a gaming machine is described in U.S. Pat. No. 6,264,561, titled “Electronic Gaming Licensing Apparatus and Method,” assigned to IGT (Reno, Nev.), which is incorporated herein by reference. In U.S. Pat. No. 6,264,561, multiple games may be stored on an EPROM. Typically, the EPROM may store up to 10 games. The method for getting a license to turn on 3 of 10 games consists of having an operator log onto the gaming machine, select the games to activate and obtain a request code for the selected games that allows them to be activated. Typically, the games are licensed for a limited time period. One disadvantage to this technique lies in the finite capacity of the storage device (EPROM in this case). While 5 or even 10 games can be stored on an EPROM, IGT's library of thousands of games cannot fit. Switching to higher capacity devices such as DVD will postpone the problem somewhat, but this device will be eventually saturated as well.

Other disadvantages are that the games are manually installed and activated. Thus, any changes or upgrades to the software on the gaming machine, such as adding a new game or fixing software on any of the games on the storage device involves replacing the entire storage device. As the number of games on the storage devices is increased and more games are made available on gaming platforms, it is likely that more frequent configuration changes on the gaming platform will be desired. As the number of configuration changes increases, it becomes more desirable to automate the configuration and licensing process.

One method to avoid swapping of the physical DVD, EPROM, etc., devices that store the game programs is to electronically download the necessary software into the gaming machine. Software download also allows a gaming machine to access scalable server farms and databases to select a set of games it needs from the game library. A desire of casino operators after games are safely downloaded is the ability to electronically move the games around on the casino floor. Casino managers routinely move slot machines (entire slot machine) around the floor in search of the optimum layout. A popular new game might be located near the door, but an older game might be better suited in the back. A Harley-Davidson™ game might be moved to the front during a biker convention, etc. Casinos often protect the arrangement of slot games as trade secrets. The laborious and costly casino floor rearrangement process needs to be expedited. When games can be electronically downloaded, they may also be electronically moved around the casino floor.

When a choice of games is offered, it complicates their distribution in part because every customer (purchaser of game software) may choose to license a unique combination of games. For example, one may choose Blackjack, Poker, and Keno while another chooses Poker, Twenty One, and Wheel of Fortune. One means to provide this would be to create a custom configuration of game software as requested by each customer. But, this “binary packaging” can be difficult and time consuming to manage especially in an envisioned environment where hundreds of new games may be introduced each year and distributed to thousands of slot machines on a typical casino floor. Another method of game licensing is to distribute all games to every customer and use an encryption technique that allows customers to ‘unlock’ only the games they are willing to buy, and install them only on the number of machines for which they have licenses. As described above, the activation is performed manually at the gaming machine. It is anticipated that it will be difficult to manage manually a game inventory mix in an environment where hundreds of new game titles may surface each year.

Manual activation schemes enforced with encryption present problems. Managers often change the selection and mix of games found in a given area of the casino because it can dramatically affect the amount of play and revenue. From the viewpoint of gaming operators, the overhead associated with manually activating encrypted games each time a game is added, deleted or transferred is a deterrent to providing gaming platform with multiple games. In addition, once the ‘key’ has been given to ‘unlock’ a particular game on one machine, it may be difficult to then revoke a key residing on a stand-alone machine. In a stand-alone machine, an operator must manually access the interior of the gaming machine and install software that revokes the key. Without the ability to ‘lock’ games once they have been ‘unlocked,’ multiple, unauthorized copies could operate simultaneously.

It is unacceptable to game content providers and gaming regulators to allow the use of unauthorized and untracked software on gaming platforms. To be properly compensated, game content providers want to know where and how much their software is being used. To ensure fairness, gaming regulators need to be able show that game software residing on a gaming machine is authentic and approved game software from an authorized content provider. In light of the above, methods that automate the game changeover process on gaming machine while providing an accurate record of the software transactions for auditing purposes and for use in utility licensing models are desirable.

In the past, a game license has been associated with the game software and the physical gaming machine that runs it. For example, the license may have been tied to a particular CPU or microprocessor on the gaming machine. In future gaming systems with gaming machines that are download enabled and contain multiple cells or cores that are capable of running multiple “virtual machines,” it is anticipated that the game software and its license may no longer be associated with the gaming machine on which it is executed. In this environment, the game software may be allowed to “float” between various gaming devices and the physical device where the game software is executed becomes less relevant. For example, a casino floor could have 3000 gaming machines/game servers with the capability of generating 10,000 games of chance simultaneously where each gaming machine has the ability to remotely generate a game outcome on the other gaming machines or download game software to the other gaming machines. For the purposes of licensing, each instantiation of a game of chance may be viewed as a “virtual” gaming machine where each “virtual” gaming machine may be licensed individually. Thus, a license management system and methods are needed to manage game licenses for the 10,000 virtual gaming machines in a manner that meets the requirements of game regulators, casino operators, gaming machine manufacturers and game software content providers.

To implement gaming downloads for operator configuration purposes as well as game-on-demand for game players, the concerns and issues of many gaming interests, such as game players, casino operators, gaming regulators and game software providers, must be considered. The concerns and issues may include but are not limited to licensing requirements, regulatory requirements, network reliability and download time. Details of apparatus and methods designed to address these concerns are described with respect to the following figures.

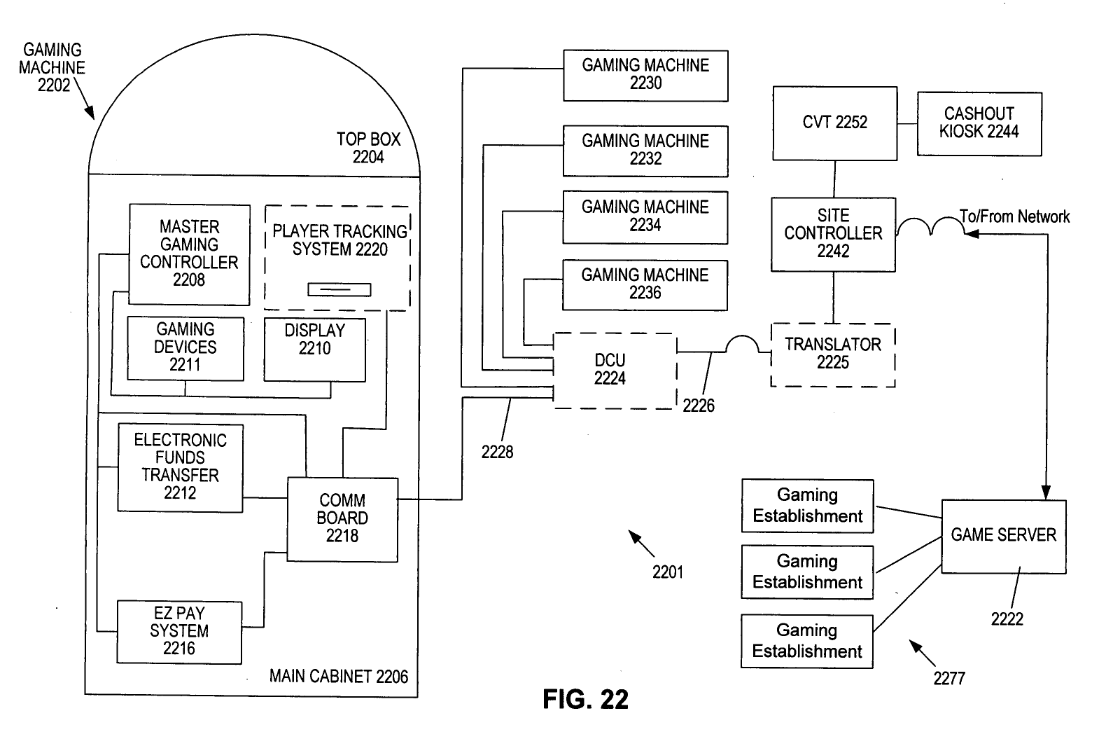

A gaming system 2277 that may be used to implement embodiments of the invention, is depicted in FIG. 22. Components of the gaming system 2277 can be situated in one or more gaming establishments. A gaming establishment 2201 could be any sort of gaming establishment, such as a casino, a card room, an airport, a store, etc. In this example, gaming system 2277 is illustrated as being associated with more than one gaming establishment, all of which are networked to game server 2222.

Here, gaming machine 2202, and the other gaming machines 2230, 2232, 2234, and 2236, include a main cabinet 2206 and a top box 2204. The main cabinet 2206 houses the main gaming elements and can also house peripheral systems, such as those that utilize dedicated gaming networks. The top box 2204 may also be used to house these peripheral systems.

The master gaming controller 2208 controls the game play on the gaming machine 2202 according to instructions and/or game data from game server 2222 or stored within gaming machine 2202 and receives or sends data to various input/output devices 2211 on the gaming machine 2202. In one embodiment, master gaming controller 2208 includes processor(s) and other apparatus of the gaming machines described above in FIG. 21. The master gaming controller 2208 may also communicate with a display 2210.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 2208 may also communicate with EFT system 2212, EZPay™ system 2216 (a proprietary cashless ticketing system of IGT), and player tracking system 2220. The systems of the gaming machine 2202 communicate the data onto the network 2228 via a communication board 2218.

It will be appreciated by those of skill in the art that embodiments of the present invention could be implemented on a network with more or fewer elements than are depicted in FIG. 22. For example, player tracking system 2220 is not a necessary feature of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment.

Moreover, DCU 2224 and translator 2225 are not required for all gaming establishments 2201. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, in the gaming industry, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 2242 provides this function for gaming establishment 2201. Site controller 2242 is connected to a central system and/or other gaming establishments via one or more networks, which may be public or private networks. Among other things, site controller 2242 communicates with game server 2222 to obtain game data, such as ball drop data, bingo card data, etc.

In the present illustration, gaming machines 2202, 2230, 2232, 2234 and 2236 are connected to a dedicated gaming network 2228. In general, the DCU 2224 functions as an intermediary between the different gaming machines on the network 2228 and the site controller 2242. In general, the DCU 2224 receives data transmitted from the gaming machines and sends the data to the site controller 2242 over a transmission path 2226. In some instances, when the hardware interface used by the gaming machine is not compatible with site controller 2242, a translator 2225 may be used to convert serial data from the DCU 2224 to a format accepted by site controller 2242. The translator may provide this conversion service to a plurality of DCUs.

Further, in some dedicated gaming networks, the DCU 2224 can receive data transmitted from site controller 2242 for communication to the gaming machines on the gaming network. The received data may be, for example, communicated synchronously to the gaming machines on the gaming network.

Here, CVT 2252 provides cashless and cashout gaming services to the gaming machines in gaming establishment 2201. Broadly speaking, CVT 2252 authorizes and validates cashless gaming machine instruments (also referred to herein as “tickets” or “vouchers”), including but not limited to tickets for causing a gaming machine to display a game result and cash-out tickets. Moreover, CVT 2252 authorizes the exchange of a cashout ticket for cash. These processes will be described in detail below. In one example, when a player attempts to redeem a cash-out ticket for cash at cashout kiosk 2244, cashout kiosk 2244 reads validation data from the cashout ticket and transmits the validation data to CVT 2252 for validation. The tickets may be printed by gaming machines, by cashout kiosk 2244, by a stand-alone printer, by CVT 2252, etc. Some gaming establishments will not have a cashout kiosk 2244. Instead, a cashout ticket could be redeemed for cash by a cashier (e.g. of a convenience store), by a gaming machine or by a specially configured CVT.

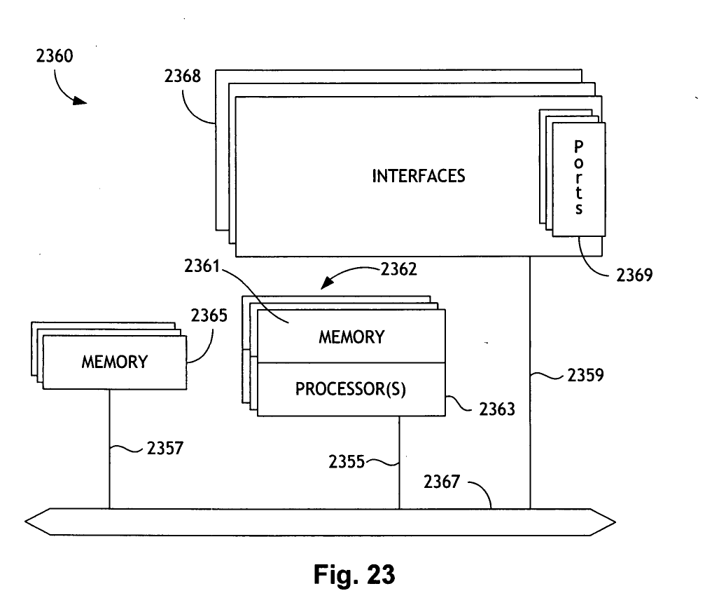

FIG. 23 illustrates an example of a network device that may be configured as a server or other data processing device for implementing some methods and apparatus of the present invention. Network device 2360 includes a master central processing unit (CPU) 2362, interfaces 2368, and a bus 2367 (e.g., a PCI bus). Generally, interfaces 2368 include ports 2369 appropriate for communication with the appropriate media. In some embodiments, one or more of interfaces 2368 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 2368 control such communications-intensive tasks as media control and management. By providing separate processors for the communications-intensive tasks, interfaces 2368 allow the master microprocessor 2362 efficiently to perform other functions such as routing computations, network diagnostics, security functions, etc.

The interfaces 2368 are typically provided as interface cards (sometimes referred to as “linecards”). Generally, interfaces 2368 control the sending and receiving of data packets over the network and sometimes support other peripherals used with the network device 2360. Among the interfaces that may be provided are FC interfaces, Ethernet interfaces, frame relay interfaces, cable interfaces, DSL interfaces, token ring interfaces, and the like. In addition, various high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 2362 may be responsible for implementing specific functions associated with the functions of a desired network device. According to some embodiments, CPU 2362 accomplishes all these functions under the control of software including an operating system and any appropriate applications software.

CPU 2362 may include one or more processors 2363 such as a processor from the Motorola family of microprocessors or the MIPS family of microprocessors. In an alternative embodiment, processor 2363 is specially designed hardware for controlling the operations of network device 2360. In a specific embodiment, a memory 2361 (such as non-volatile RAM and/or ROM) also forms part of CPU 2362. However, there are many different ways in which memory could be coupled to the system. Memory block 2361 may be used for a variety of purposes such as, for example, caching and/or storing data, programming instructions, etc.

Regardless of the network device's configuration, it may employ one or more memories or memory modules (such as, for example, memory block 2365) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 23 illustrates one specific data processing device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 23) or switch fabric based (such as a cross-bar).

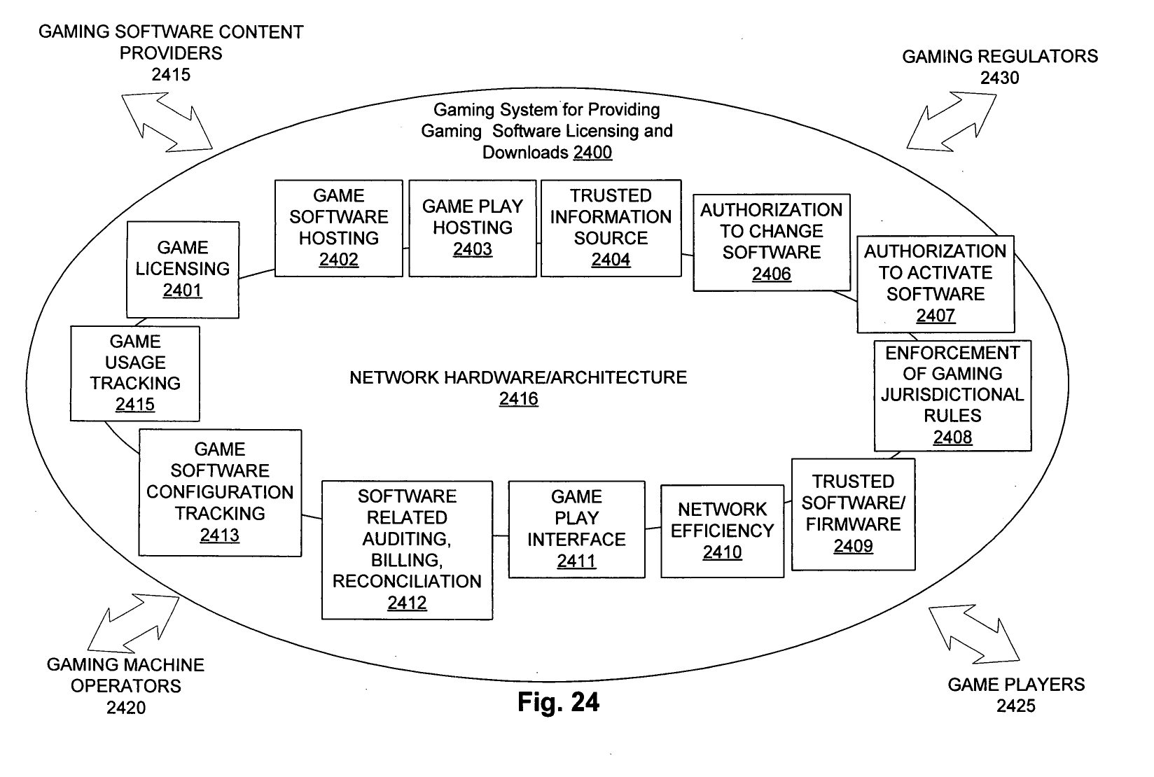

In FIG. 24, the components of a gaming system 2400 for providing game software licensing and downloads are described functionally. The described functions may be instantiated in hardware, firmware and/or software and executed on a suitable device. In the system 2400, there may be many instances of the same function, such as multiple game play interfaces 2411. Nevertheless, in FIG. 24, only one instance of each function is shown. The functions of the components may be combined. For example, a single device may comprise the game play interface 2411 and include trusted software and firmware 2409.

The gaming system 2400 may receive inputs from different groups/entities and output various services and/or information to these groups/entities. For example, game players 2425 primarily input cash or indicia of credit into the system, make game selections that trigger software downloads, and receive entertainment in exchange for their inputs. Game software content providers 2415 provide game software for the system and may receive compensation for the content they provide based on licensing agreements with the gaming machine operators. Gaming machine operators 2420 select game software for distribution, distribute the game software on the gaming devices in the system 2400, and receive revenue for the use of their software to compensate the gaming machine operators. The gaming regulators 2430 may provide rules and regulations that must be applied to the gaming system and may receive reports and other information confirming that rules are being obeyed.

In the following paragraphs, details of each component and some of the interactions between the components are described with respect to FIG. 24. The game software licensing host 2401 may be a server connected to a number of remote gaming devices that provides licensing services to the remote gaming devices. For example, in some embodiments, the license host 2401 may 1) receive token requests for tokens used to activate software executed on the remote gaming devices, 2) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host 2415 may track the usage of game software on a plurality of devices in communication with the host. The game usage-tracking host 2415 may be in communication with a plurality of game play hosts and gaming machines. From the game play hosts and gaming machines, the game usage tracking host 2415 may receive updates of an amount that each game available for play on the devices has been played and an amount that has been wagered per game. This information may be stored in a database and used for billing according to methods described in a utility based licensing agreement.

The game software host 2402 may provide game software downloads, such as downloads of game software or game firmware, to various devices in the game system 2400. For example, when the software to generate the game is not available on the game play interface 2411, the game software host 2402 may download software to generate a selected game of chance played on the game play interface. Further, the game software host 2402 may download new game content to a plurality of gaming machines via a request from a gaming machine operator.

In one embodiment, the game software host 2402 may be combined with a game software configuration-tracking host 2413. The function of the game software configuration-tracking host is to keep records of software configurations and/or hardware configurations for a plurality of devices in communication with the host (e.g., denominations, number of paylines, paytables, max/min bets). Details of a game software host and a game software configuration host that may be used with the present invention are described in commonly assigned U.S. Pat. No. 6,645,077, by Rowe, entitled, “Gaming Terminal Data Repository and Information System,” filed Dec. 21, 2000, which is hereby incorporated by reference.

A game play host device 2403 may be a host server connected to a plurality of remote clients that generates games of chance that are displayed on a plurality of remote game play interfaces 2411. For example, the game play host device 2403 may be a server that provides central determination for a bingo game play played on a plurality of connected game play interfaces 2411. As another example, the game play host device 2403 may generate games of chance, such as slot games or video card games, for display on a remote client. A game player using the remote client may be able to select from a number of games that are provided on the client by the host device 2403. The game play host device 2403 may receive game software management services, such as receiving downloads of new game software, from the game software host 2402 and may receive game software licensing services, such as the granting or renewing of software licenses for software executed on the device 2403, from the game license host 2401.

In particular embodiments, the game play interfaces or other gaming devices in the gaming system 2400 may be portable devices, such as electronic tokens, cell phones, smart cards, tablet PC's and PDA's. The portable devices may support wireless communications and thus may be referred to as wireless mobile devices. The network hardware architecture 2416 may be enabled to support communications between wireless mobile devices and other gaming devices in gaming system. In one embodiment, the wireless mobile devices may be used to play games of chance.

The gaming system 2400 may use a number of trusted information sources. Trusted information sources 2404 may be devices, such as servers, that provide information used to authenticate/activate other pieces of information. CRC values used to authenticate software, license tokens used to allow the use of software or product activation codes used to activate software are examples of trusted information that might be provided from a trusted information source 2404. Trusted information sources may be a memory device, such as an EPROM, that includes trusted information used to authenticate other information. For example, a game play interface 2411 may store a private encryption key in a trusted memory device that is used in a private key-public key encryption scheme to authenticate information from another gaming device.

When a trusted information source 2404 is in communication with a remote device via a network, the remote device will employ a verification scheme to verify the identity of the trusted information source. For example, the trusted information source and the remote device may exchange information using public and private encryption keys to verify each other's identities. In another embodiment of the present invention, the remote device and the trusted information source may engage in methods using zero knowledge proofs to authenticate each of their respective identities. Details of zero knowledge proofs that may be used with the present invention are described in U.S. Patent Application No. 2003/0203756, by Jackson, filed on Apr. 25, 2002 and entitled, “Authentication in a Secure Computerized Gaming System,” which is hereby incorporated by reference.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming system 2400 of the present invention may include devices 2406 that provide authorization to download software from a first device to a second device and devices 2407 that provide activation codes or information that allow downloaded software to be activated. The devices, 2406 and 2407, may be remote servers and may also be trusted information sources. One example of a method of providing product activation codes that may be used with the present invention is describes in previously incorporated U.S. Pat. No. 6,264,561.

A device that monitors a plurality of gaming devices to determine adherence of the devices to gaming jurisdictional rules 2408 may be included in the system 2400. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as a CRC, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum bet limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing on a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may be used to check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 2400 may utilize trusted software and/or trusted firmware. Trusted firmware/software is trusted in the sense that it is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, i.e., game software approved for use on gaming devices by a local gaming jurisdiction may be required on gaming devices on the gaming machine.

In the present invention, the devices may be connected by a network 2416 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, in the present inventions, network efficient devices 2410 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in the present invention may provide game software and game licensing related auditing, billing and reconciliation reports to server 2412. For example, a software licensing billing server may generate a bill for a gaming device operator based upon a usage of games over a time period on the gaming devices owned by the operator. In another example, a software auditing server may provide reports on game software downloads to various gaming devices in the gaming system 2400 and current configurations of the game software on these gaming devices.

At particular time intervals, the software auditing server 2412 may also request software configurations from a number of gaming devices in the gaming system. The server may then reconcile the software configuration on each gaming device. In one embodiment, the software auditing server 2412 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 24. Many of the interactions are coupled. For example, methods used for game licensing may affect methods used for game downloading and vice versa. For the purposes of explanation, details of a few possible interactions between the components of the system 2400 relating to software licensing and software downloads have been described. The descriptions are selected to illustrate particular interactions in the game system 2400. These descriptions are provided for the purposes of explanation only and are not intended to limit the scope of the present invention.

While the invention has been particularly shown and described with reference to specific embodiments thereof, it will be understood by those skilled in the art that changes in the form and details of the disclosed embodiments may be made without departing from the spirit or scope of the invention. For example, the techniques of the present invention may be employed to enhance data analysis capabilities for any type of relational database, e.g., consumer and other marketing databases. It should also be understood that, for example, the exemplary embodiment of FIG. 3 is merely presented for illustrative purposes and that not all of the process elements described must be practiced to be within the scope of the invention. It should also be understood that the techniques of the present invention may be applied to a relational data set comprising a plurality of player tracking databases corresponding to multiple gaming properties whereby subsets of individuals with at least one common attribute are created from sets of individuals corresponding to more than one of the gaming property databases.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for customizing a game application for a player to play a game of chance on a gaming machine, the method comprising the steps of:
providing a plurality of attributes, the attributes including at least one attribute relating to gaming behavior of associated individuals;
comparing values of selected attributes associated with ones of a set of the individuals with values of the selected attributes associated with others of the set of the individuals to determine at least one attribute difference representing at least one difference among the values of the plurality of attributes;
defining a subset of the set of individuals, each of the individuals in the subset having the at least one attribute difference in common;
receiving player identification information for the player;
retrieving, responsive to receiving the player identification information, player attributes for the player;
determining, based on the retrieved player attributes for the player, that the player belongs to the subset of individuals;
obtaining the attribute difference associated with the subset of individuals; and
defining an element of the game application according to the obtained at least one attribute difference.

2. The method of claim 1, wherein the element of the game application relates to presentation of the game of chance.

3. The method of claim 2, wherein the element of the game application includes a game presentation file.

4. The method of claim 3, wherein the game presentation file is selected from the group consisting of a model file, a script file, and a presentation module.

5. The method of claim 2, wherein the element of the game application includes a presentation state.

6. The method of claim 5, wherein the presentation state includes audio data.

7. The method of claim 5, wherein the presentation state includes video data.

8. The method of claim 5, wherein the presentation state includes object data.

9. The method of claim 1, wherein the element of the game application relates to flow of the game of chance.

10. The method of claim 9, wherein the element of the game application includes a game state.

11. The method of claim 9, wherein defining the element of the game application includes:
determining a sequence of game states according to the at least one attribute difference; and
defining a path for flow of the game of chance as the determined sequence of game states.

12. The method of claim 11, wherein determining the sequence of game states according to the at least one attribute difference includes:
selecting one of a plurality of game states as a branch for the flow of the game of chance.

13. The method of claim 9, wherein the element of the game application includes a game software module.

14. The method of claim 1, wherein the element of the game application relates to an alternate stage of the game of chance.

15. The method of claim 14, wherein the alternate stage of the game of chance is selected from the group consisting of a bonus stage, a prize, and a promotion.

16. The method of claim 1, wherein defining the element of the game application includes selecting the element.

17. The method of claim 1, wherein defining the element of the game application includes modifying the element.

18. The method of claim 1, wherein the at least one attribute difference includes a single relational polymorphism (SRP).

19. The method of claim 1, wherein the at least one attribute difference corresponds to at least one of age, geographical region, gender, income, frequency of play, favorite day to play, favorite time to play, average amount bet, total amount played, game preference, denomination preference, cuisine preference, beverage preference, music preference, and date of birth.

20. A method for providing a customized game application for a player to play a game of chance on the gaming machine using an attribute difference among attributes relating to gaming behavior of associated individuals, the attribute difference determined by comparing values of selected attributes associated with ones of a set of the individuals with values of the selected attributes associated with others of the set of the individuals, the attribute difference representing at least one difference among the values of the plurality of attributes, a subset of the set of individuals defined so that each of the individuals in the subset have the at least one attribute difference in common, the method comprising the steps of:
receiving player identification information for the player;
determining, based on the received player identification information for the player, that the player belongs to the subset of individuals;
retrieving the attribute difference associated with the subset of individuals; an
defining an element of the game application according to the obtained at least one attribute difference, the defined element of the game application being provided for execution of the game application on the gaming machine, including output of the defined element, for play of the game of chance.

21. The method of claim 20, wherein the element of the game application relates to presentation of the game of chance.

22. The method of claim 21, wherein the element of the game application includes a game presentation file.

23. The method of claim 21, wherein the element of the game application includes a presentation state.

24. The method of claim 20, wherein the element of the game application relates to flow of the game of chance.

25. The method of claim 24, wherein the element of the game application includes a game state.

26. The method of claim 20, wherein the element of the game application relates to an alternate stage of the game of chance.

27. The method of claim 26, wherein the alternate stage of the game of chance is selected from the group consisting of a bonus stage, a prize, and a promotion.

28. The method of claim 20, wherein the at least one attribute difference includes a single relational polymorphism (SRP).

29. The method of claim 20, wherein the at least one attribute difference corresponds to at least one of age, geographical region, gender, income, frequency of play, favorite day to play, favorite time to play, average amount bet, total amount played, game preference, denomination preference, cuisine preference, beverage preference, music preference, and date of birth.

30. A gaming machine capable of providing a customized game application for a player to play a game of chance on the gaming machine using an attribute difference among attributes relating to gaming behavior of associated individuals, the attribute difference determined by comparing values of selected attributes associated with ones of a set of the individuals with values of the selected attributes associated with others of the set of the individuals, the attribute difference representing at least one difference among the values of the plurality of attributes, a subset of the set of individuals defined so that each of the individuals in the subset have the at least one attribute difference in common, the gaming machine comprising:
an interface capable of receiving player identification information for the player;
a gaming controller including one or more processors, the gaming controller coupled to the interface and configured to:
i) retrieve, responsive to the interface receiving the player identification information, player attributes for the player from a storage medium;
ii) determine, based on the retrieved player attributes for the player, that the player belongs to the subset of individuals;
iii) obtain the attribute difference associated with the subset of individuals;
iv) define an element of the game application according to the obtained at least one attribute difference; and
v) execute the game application, including output of the defined element, for play of the game of chance.

31. The gaming machine of claim 30, wherein the element of the game application relates to presentation of the game of chance.

32. The gaming machine of claim 30, wherein the element of the game application relates to flow of the game of chance.

33. The gaming machine of claim 30, wherein the element of the game application relates to an alternate stage of the game of chance.

34. The gaming machine of claim 30, wherein defining the element of the game application includes selecting the element.

35. The gaming machine of claim 30, wherein defining the element of the game application includes modifying the element.

36. The gaming machine of claim 30, wherein the at least one attribute difference includes a single relational polymorphism (SRP).

37. The gaming machine of claim 30, wherein the interface includes a player tracking unit.

38. The gaming machine of claim 30, wherein the interface includes a gaming network interface.

39. The gaming machine of claim 30, further comprising:
a display coupled to the gaming controller, the display capable of outputting a graphical characteristic of the defined element.

40. A data processing device in communication with a gaming machine over a data network and coupled to provide a customized game application for a player to play a game of chance on the gaming machine using an attribute difference among attributes relating to gaming behavior of associated individuals, the attribute difference determined by comparing values of selected attributes associated with ones of a set of the individuals with values of the selected attributes associated with others of the set of the individuals, the attribute difference representing at least one difference among the values of the plurality of attributes, a subset of the set of individuals defined so that each of the individuals in the subset have the at least one attribute difference in common, the data processing device comprising:
an interface capable of receiving player identification information for the player;
at least one processor coupled to the interface and configured to:
i) retrieve, responsive to receiving the player identification information, player attributes for the player from a storage medium;
ii) determine, based on the retrieved player attributes for the player, that the player belongs to the subset of individuals;
iii) obtain the attribute difference associated with the subset of individuals; and
iv) define an element of the game application according to the obtained at least one attribute difference, the defined element of the game application being provided to the gaming machine for execution of the game application, including output of the defined element, for play of the game of chance.

41. The data processing device of claim 40, wherein the element of the game application relates to presentation of the game of chance.

42. The data processing device of claim 40, wherein the element of the game application relates to flow of the game of chance.

43. The data processing device of claim 42, wherein defining the element of the game application includes:
determining a sequence of game states according to the at least one attribute difference; and
defining a path for flow of the game of chance as the determined sequence of game states.

44. The data processing device of claim 43, wherein determining the sequence of game states according to the at least one attribute difference includes:
selecting one of a plurality of game states as a branch for the flow of the game of chance.

45. The data processing device of claim 40, wherein the element of the game application relates to an alternate stage of the game of chance.

46. The data processing device of claim 40, wherein defining the element of the game application includes selecting the element.

47. The data processing device of claim 40, wherein defining the element of the game application includes modifying the element.

48. The data processing device of claim 40, wherein the at least one attribute difference includes a single relational polymorphism (SRP).

49. The data processing device of claim 40, wherein the at least one attribute difference corresponds to at least one of age, geographical region, gender, income, frequency of play, favorite day to play, favorite time to play, average amount bet, total amount played, game preference, denomination preference, cuisine preference, beverage preference, music preference, and date of birth.
